(19) United States
(12) Patent Application Publication
(10) Pub. No.: US 2026/0095222 A1
(43) Pub. Date: Apr. 2, 2026

(54) CHANNEL STATE INFORMATION REPORTING FOR MULTIPLE SPATIAL DOMAIN ADAPTATIONS IN A WIRELESS COMMUNICATIONS SYSTEM

(71) Applicant: Lenovo (United States) Inc., Morrisville, NC (US)

(72) Inventors: Ahmed HINDY, Aurora, IL (US); Mahdi Barzegar Khalilsarai, Berlin (DE)

(21) Appl. No.: 18/903,891

(22) Filed: Oct. 1, 2024

(51) Int. Cl. H04B 7/06

(52) U.S. Cl. CPC H04B 7/0626; H04B 7/0617

(57) ABSTRACT

Various aspects of the present disclosure relate to a framework that supports a UE performing efficient channel state information (CSI) measurement and/or reporting for multiple spatial domain adaptations of a network. For example, the framework may facilitate the signaling of antenna ports associated with the multiple spatial domain adaptation patterns employed by the network, which enables the UE to generate CSI reports that include information for the antenna ports, such as information for different subsets of antenna ports that are associated with each of the multiple spatial domain adaptation patterns.

### TECHNICAL FIELD

The present disclosure relates to wireless communications, and more specifically to channel state information (CSI) reporting for multiple spatial domain adaptations in a wireless communications system.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support massive multiple-input, multiple-output (MIMO) technology, which can improve the capacity of the network, data rates, and spectral efficiency. For example, the wireless communications system may utilize massive MIMO network nodes to improve spatial diversity and/or multiplexing gains for a network. A network may realize energy savings by using spatial domain adaptation for downlink (DL) transmissions, where a subset of antennas is active based on performance and/or energy efficiency. Further, UEs may be configured with multiple spatial domain adaptation patterns to accommodate for the spatial domain adaptation employed by the network.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that enable a UE to perform CSI measurement and/or CSI reporting for multiple spatial domain adaptations.

Some implementations of the method and apparatuses described herein may further include a UE for wireless communication, comprising at least one memory and at least one processor coupled with the at least one memory and configured to cause the UE to receive a configuration for CSI reporting, wherein the configuration includes a set of metrics, receive a CSI reference signal (CSI-RS) associated with-a set of CSI-RS ports, identify a subset of CSI-RS ports from the set of CSI-RS ports based on the configuration, generate a set of CSI parameters comprising a first group of CSI parameter values associated with the set of CSI-RS ports and a second group of CSI parameter values associated with the subset of CSI-RS ports, wherein a subset of the second group of CSI parameter values is based at least in part on the first group of CSI parameter values, and transmit a CSI report comprising a subset of the set of CSI parameters based on the set of metrics.

In some implementations of the method and apparatuses described herein, the CSI report comprises one or more precoder matrix indicator (PMI) values comprising coefficients associated with the set of CSI-RS ports, one or more rank indicator (RI) values associated with the set of CSI-RS ports, a first channel quality indicator (CQI) value associated with the set of CSI-RS ports, and a second CQI value associated with the subset of CSI-RS ports.

In some implementations of the method and apparatuses described herein, the first group of CSI parameters values comprises a PMI value of the one or more PMI values, an RI value of the one or more RI values, and wherein the first CQI value and the second group of CSI parameter values comprises the second CQI value.

In some implementations of the method and apparatuses described herein, at least one of a precoding matrix associated with the subset of CSI-RS ports is inferred from the PMI value and a rank value associated with the subset of CSI-RS ports is inferred from the RI value.

In some implementations of the method and apparatuses described herein, the at least one processor is configured to cause the UE to receive the CSI-RS over one or more non-zero power (NZP) CSI-RS resources, and wherein the one or more NZP CSI-RS resources comprise one or more groups of CSI-RS ports that correspond to the set of CSI-RS ports.

In some implementations of the method and apparatuses described herein, the set of CSI-RS ports are distributed over two dimensions, and wherein the at least one processor is further configured to cause the UE to select the subset of CSI-RS ports independently over each dimension of the two dimensions.

In some implementations of the method and apparatuses described herein, the set of metrics comprises a difference between a first channel quality indicator (CQI) value and a second CQI value being less than or equal to a first threshold value, a difference between a first rank indicator (RI) value associated with the set of CSI-RS ports and a second RI value associated with the subset of CSI-RS ports being less than or equal to a second threshold value, and a range of values for a quantity of CSI-RS ports of the set of CSI-RS ports satisfies a set of conditions associated with a layout of the CSI-RS ports, or a combination thereof.

In some implementations of the method and apparatuses described herein, the subset of the set of CSI parameters comprises the first group of values and the second group of values based at least in part on the set of metrics being satisfied, or wherein the subset of the set of CSI parameters comprises the first group of values based at least in part on the set of metrics not being satisfied.

In some implementations of the method and apparatuses described herein, a number of CSI-RS ports of the subset of CSI-RS ports are consecutive over at least one dimension; or the number of CSI-RS ports of the subset of CSI-RS ports are non-consecutive over the at least one dimension and with uniform gaps between each CSI-RS port and subsequent CSI-RS port of the number of CSI-RS ports.

In some implementations of the method and apparatuses described herein, coefficients of one or more PMI values are based on a codebook comprising a set of columns of a discrete Fourier transform (DFT)-based matrix.

In some implementations of the method and apparatuses described herein, an indexing of columns of the DFT-based matrix is circular, wherein a last column of the DFT-based matrix and a first column of the DFT-based matrix are consecutive columns.

In some implementations of the method and apparatuses described herein, the subset of CSI-RS ports corresponds to the number of CSI-RS ports that are non-consecutive, and wherein the codebook is based on a subset of consecutive columns of the DFT-based matrix.

In some implementations of the method and apparatuses described herein, the subset of CSI-RS ports corresponds to a sequence of alternating antenna ports over the at least one dimension, and the codebook is based on a subset of consecutive columns of the DFT-based matrix.

In some implementations of the method and apparatuses described herein, the second group of CSI parameter values further comprises an indication of a subset of columns of the DFT-based matrix based on the subset of CSI-RS ports, an indication of the subset of CSI-RS ports, or a combination thereof.

Some implementations of the method and apparatuses described herein may further include a network node for wireless communication, comprising at least one memory, and at least one processor coupled with the at least one memory and configured to cause the network node to transmit, to a UE, a configuration for CSI reporting that includes a set of metrics, transmit, to the UE, a CSI-RS identifying a set of CSI-RS ports, and receive, from the UE, a CSI report that comprises values associated with the set of CSI-RS ports and values associated with a subset of CSI-RS ports.

In some implementations of the method and apparatuses described herein, the configuration includes information identifying a spatial adaption pattern or antenna array at the network node that is associated with the subset of CSI-RS antenna ports.

In some implementations of the method and apparatuses described herein, the configuration includes information an indication of a quantity of CS-RS ports of the subset of CSI-RS antenna ports.

Some implementations of the method and apparatuses described herein may further include a processor for wireless communication, comprising at least one controller coupled with at least one memory and configured to cause the processor to receive a configuration for CSI reporting, wherein the configuration includes a set of metrics, receive a CSI-RS associated with-a set of CSI-RS ports, identify a subset of CSI-RS ports from the set of CSI-RS ports based on the configuration, generate a set of CSI parameters comprising a first group of CSI parameter values associated with the set of CSI-RS ports and a second group of CSI parameter values associated with the subset of CSI-RS ports, wherein a subset of the second group of CSI parameter values is based at least in part on the first group of CSI parameter values, and transmit a CSI report comprising a subset of the set of CSI parameters based on the set of metrics.

In some implementations of the method and apparatuses described herein, the CSI report comprises one or more PMI values comprising coefficients associated with the set of CSI-RS ports, one or more RI values associated with the set of CSI-RS ports, a first CQI value associated with the set of CSI-RS ports, and a second CQI value associated with the subset of CSI-RS ports.

Some implementations of the method and apparatuses described herein may further include a method performed by a UE the method comprising receiving a configuration for CSI reporting, wherein the configuration includes a set of metrics, receiving a CSI-RS associated with-a set of CSI-RS ports, identifying a subset of CSI-RS ports from the set of CSI-RS ports based on the configuration, generating a set of CSI parameters comprising a first group of CSI parameter values associated with the set of CSI-RS ports and a second group of CSI parameter values associated with the subset of CSI-RS ports, wherein a subset of the second group of CSI parameter values is based at least in part on the first group of CSI parameter values, and transmitting a CSI report comprising a subset of the set of CSI parameters based on the set of metrics.

### BRIEF DESCRIPTION OF THE DRAWINGS

FIG. 1 illustrates an example of a wireless communications system in accordance with aspects of the present disclosure.

FIG. 2 illustrates an example block diagram that depicts communications between a UE and a network entity in accordance with aspects of the present disclosure.

FIG. 3 illustrates an example diagram of an array of antennas in accordance with aspects of the present disclosure.

FIG. 4 illustrates an example diagram of a selection of antennas in accordance with aspects of the present disclosure.

FIG. 5 illustrates an example signaling between a UE and a network entity in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In some wireless communication systems, a UE is configured with multiple spatial domain adaptation patterns, where each pattern is configured separately and/or distinctly. Due to the separate/distinct configurations, the UE performs CSI measurement and/or reporting separately for each pattern of the multiple spatial domain adaptation patterns. For example, the wireless communications system benefits from supporting CSI feedback operations (e.g., CSI measurement and reporting) for the multiple spatial domain adaptation patterns, such as by using the CSI feedback when selecting antenna ports for DL transmissions (e.g., physical downlink shared channel (PDSCH) transmissions) to improve its energy efficiency.

While a network may realize energy savings with such an arrangement, energy savings at the UE may be reduced, because the UE (or a group of UEs) performs additional CSI measurement/reporting for each of the different spatial domain adaptation patterns. The technology described herein provides a framework that supports a UE performing efficient CSI measurement and/or reporting for multiple spatial domain adaptations. For example, the framework may facilitate the signaling of antenna ports associated with the multiple spatial domain adaptation patterns employed by the network, which enables the UE to generate CSI reports that include information for the antenna ports, such as information for different subsets of antenna ports that are associated with each of the multiple spatial domain adaptation patterns.

Thus, in various embodiments, a wireless communications system may employ spatial domain adaptation without increasing the operations performed by the UEs, because the UEs perform CSI measurement and reporting for various spatial domain adaptation patterns efficiently and for all sets or subsets of available antenna ports associated with the spatial domain adaptation patterns, among other benefits.

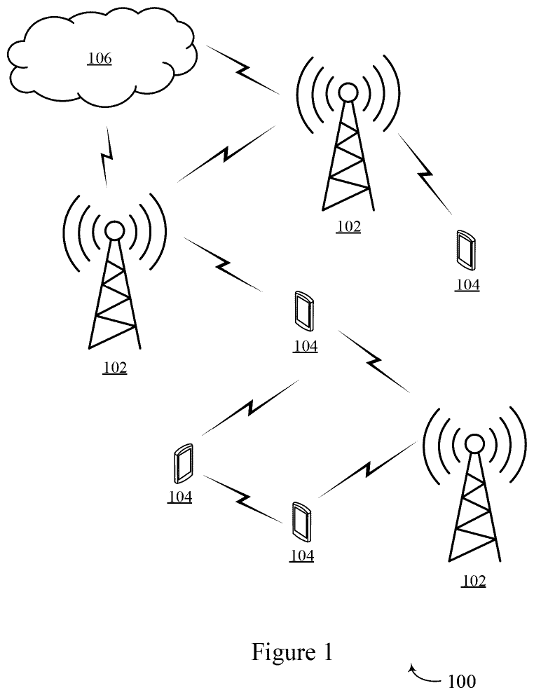

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, the wireless communications system 100 facilitates the performance of CSI measurement and/or reporting by UEs (e.g., the UE 104) on behalf of and/or requested by the network (e.g., the NE 102). The following aspects support the performance of CSI measurement/reporting.

The UE 104 supports codebooks, which are predefined patterns used by the UE 104 when measuring and/or reporting the quality of a radio channel (e.g., CSI measurement/reporting). The UE 104 may employ different codebook types, such as a Type-II codebook (e.g., a Release 15 Type-II codebook), a Type-I codebook (e.g., a Release 15 Type-I codebook), and so on. The following details expand upon the different codebook types employed by the UE 104.

### Rel-15 Type-II Codebook

Assume a gNodeB (gNB) is equipped with a two-dimensional (2D) antenna array with N₁, N₂ antenna ports per polarization placed horizontally and vertically and communication occurs over N₃ PMI sub-bands, and a pre-coding matrix indicator (PMI) subband includes a set of resource blocks, each resource block consisting of a set of subcarriers. In such cases, 2N₁N₂ CSI-RS ports are utilized to enable DL channel estimation with high resolution for a Type-II codebook. In order to reduce uplink (UL) feedback overhead, a Discrete Fourier transform (DFT)-based CSI compression of the spatial domain is applied to L dimensions per polarization, where L<N₁N₂. In the sequel the indices of the 2L dimensions are referred to as Spatial Domain (SD) basis indices. The magnitude and phase values of the linear combination coefficients for each sub-band are fed back to the gNB as part of the CSI report. The 2N₁N₂×N₃ codebook per layer/takes on the form:

$${W}_{l} = {W}_{1} {W}_{2 , l} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and B is an N₁N₂XL matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${ν}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} ,$$

$$B = [ \begin{matrix}{ν}_{{l}_{0} , {m}_{0}} & {ν}_{{l}_{1} , {m}_{1}} & … & {ν}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation. Note that O₁, O₂ oversampling factors are assumed for the 2D DFT matrix from which matrix B is drawn. Note that W₁ is common across all layers. W_{2,t} is a 2Lx N₃ matrix, where the i^{th} column corresponds to the linear combination coefficients of the 2L beams in the i^{th} sub-band. Only the indices of the L selected columns of B are reported, along with the oversampling index taking on O₁O₂ values. Note that W_{2,t} are independent for different layers.

### Rel-15 Type-II Port Selection Codebook

For the Type-II Port Selection codebook, only K (where K≤2N₁N₂) beamformed CSI-RS ports are utilized in DL transmission, in order to reduce complexity. The K×N₃ codebook matrix per layer takes on the form:

$${W}_{l} = {W}_{1}^{PS} {W}_{2 , l} .$$

W₂ follows the same structure as the conventional Type-II Codebook and are layer specific.

$${W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] , where {e}_{i}^{( K )}$$

is a standard unit vector with a 1 at the i^{th} location. Here d_{PS} is an RRC parameter which takes on the values {1,2,3,4} under the condition d_{PS}≤min (K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0, 1, . . . , 7} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

When d_{PS}=2, the 4 possible realizations of E corresponding to m_{PS}={0,1,2,3} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows:

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

Thus, m_{PS} parametrizes the location of the first 1 in the first column of E, whereas d_{PS} represents the row shift corresponding to different values of m_{PS}.

### Rel-15 Type-I Single-Panel Codebook

The Type-I codebook (e.g., a Release 15 Type-I codebook) is the baseline codebook for NR, with a variety of configurations. The most common utility of the Type-I codebook is a special case of the Type-II codebook with L=1 for RI=1, 2, wherein a phase coupling value is reported for each sub-band, i.e., W_{2,t} is 2×N₃, with the first row equal to [1, 1, . . . , 1] and the second row equal to [e^{j2πØ}^{₀}, . . . , e^{j2πØ}^{_{N3-1}}]. Under specific configurations, φ₀=φ₁ . . . =φ, i.e., wideband reporting. For RI>2 different beams are used for each pair of layers. The Type-I codebook can be depicted as a low-resolution version of the Type-II codebook with spatial beam selection per layer-pair and phase combining only.

### Rel-16 Type-II Codebook

Similar to the Release 15 Type-II Codebook, the Release 16 Type-II Codebook utilizes 2N₁N₂N₃ CSI-RS ports to enable DL channel estimation with high resolution. In order to reduce the UL feedback overhead, a Discrete Fourier transform (DFT)-based CSI compression of the spatial domain is applied to L dimensions per polarization, where L<N₁N₂. Similarly, additional compression in the frequency domain is applied, where each beam of the frequency-domain precoding vectors is transformed using an inverse DFT matrix to the delay domain, and the magnitude and phase values of a subset of the delay-domain coefficients are selected and fed back to the gNB as part of the CSI report. The 2N₁N₂×N₃ codebook per layer takes on the form:

$${W}_{l} = {W}_{1} {\tilde{W}}_{2 , l} {W}_{f , l}^{H} ,$$

where W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and Bis an N₁N₂×L matrix with columns drawn from a 2D oversampled DFT matrix, as follows.

$$\begin{matrix}{u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] , \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} , \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] , \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} ,\end{matrix}$$

where the superscript T denotes a matrix transposition operation. Note that O₁, O₂ oversampling factors are assumed for the 2D DFT matrix from which matrix B is drawn. Note that W₁ is common across all layers. W_{f} is an N₃×M matrix (M<N₃) with columns selected from a critically-sampled size-N₃ DFT matrix, as follows:

$$\begin{matrix}\begin{matrix}{W}_{f , l} = [ \begin{matrix}{f}_{{k}_{0}} & {f}_{{k}_{1}} & … & {f}_{{k}_{M ′ - 1}}\end{matrix} ] , & 0 \leq {k}_{i} \leq {N}_{3} - 1 ,\end{matrix} \\ {f}_{k} = [ \begin{matrix}1 & {e}^{- j \frac{2 π k}{{N}_{3}}} & … & {{e}^{- j \frac{2 π k ( {N}_{3} - 1 )}{{N}_{3}}} ]}^{T}\end{matrix} .\end{matrix}$$

Only the indices of the L selected columns of B are reported, along with the oversampling index taking on O₁O₂ values. Similarly, for W_{f,l}, only the indices of the M selected columns out of the predefined size-N₃ DFT matrix are reported. In the sequel the indices of the M dimensions are referred as the selected Frequency Domain (FD) basis indices. Hence, L, M represent the equivalent spatial and frequency dimensions after compression, respectively. Finally, the 2L×M matrix \tilde{W}₂ represents the linear combination coefficients (LCCs) of the spatial and frequency DFT-basis vectors. Both \tilde{W}₂, W_{f} are selected independent for different layers. Amplitude and phase values of an approximately β fraction of the 2LM available coefficients are reported to the gNB (β<1) as part of the CSI report. Coefficients with zero magnitude are indicated via a per-layer bitmap, with the strongest coefficient amplitude set to one, and an index of the strongest coefficient reported. No amplitude or phase information is explicitly reported for this coefficient. Amplitude and phase values of a maximum of ┌2βLM┐−1 coefficients, compared with 2N₁N₂×N₃−1 coefficients of a theoretical design.

### Rel-16 Type-II Port Selection Codebook

For the Release 16 Type-II Port Selection codebook, only K (where K≤2N₁N₂) beamformed CSI-RS ports are utilized in DL transmission, in order to reduce complexity. The K×N₃ codebook matrix per layer takes on the form:

$${W}_{l} = {W}_{1}^{PS} {\tilde{W}}_{2 , l} {W}_{f , l}^{H} ,$$

\tilde{W}_{2,l} and W_{3,l} follow the same structure as the conventional Release 16 Type-II Codebook, where both are layer specific. The matrix

$${W}_{1}^{PS}$$

is a K×2L block-diagonal matrix with the same structure as that in the Release 15 Type-II Port Selection Codebook.

### Rel-17 Type-II Port Selection Codebook

The Release 17 Type-II Port Selection Codebook follows a similar structure as that of Rel. 15 and Rel. 16 port-selection codebooks, as follows:

$${W}_{l} = {\overline{W}}_{1}^{PS} {\tilde{W}}_{2 , l} {W}_{f , l}^{H} ,$$

However, unlike the other Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, i.e.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,l} and W_{f,l} follow the same structure as the conventional Release 16 Type-II Codebook, however M is limited to 1,2 only, with the network configuring a window of size N={2,4} for M=2. Moreover, the bitmap is reported unless β=1 and the UE reports all the coefficients for a rank up to a value of two.

### CSI Reporting

As described herein, the network employs the UE 104 to perform CSI measurement and reporting, in order to measure the quality of a radio channel or channels. In some cases, the UE 104 may generate a CSI report (e.g., a codebook report) that is partitioned into two parts based on the priority of information reported. Each part is encoded separately (e.g., Part 1 having higher code rate). The following are example parameters in a CSI report (e.g., for a Release 16 Type-II codebook):

$$Part 1 : RI + CQI + Total number of coefficients ; and$$

$$Part 2 : SD basis indicator + FD basis indicator / layer + Bitmap / layer + Coefficient Amplitude info / layer + Coefficient Phase info / layer + Strongest coefficient indicator / layer$$

In some cases, the Part 2 CSI can be decomposed into sub-parts, each with different priority (e.g., higher priority information listed first). Such partitioning may allow a dynamic reporting size for codebook based on available resources in the uplink phase. Also, a Type-II codebook is based on aperiodic CSI reporting, and only reported in a physical uplink shared channel (PUSCH) via downlink control information (DCI) triggering (with one exception). A Type-I codebook can be based on periodic CSI reporting (e.g., physical uplink control channel (PUCCH)) or semi-persistent CSI reporting (PUSCH or PUCCH) or aperiodic reporting (PUSCH).

The UE 104 may report CSI information for the network using the CSI framework in NR Release 15. The triggering mechanism between a report setting and a resource setting is summarized in Table 1:

TABLE 1
Triggering mechanism between a report
setting and a resource setting

| | | Periodic CSI | SP CSI | AP CSI |
|---|---|---|---|---|
| | | reporting | reporting | Reporting |
| Time | Periodic CSI- | RRC | MAC CE | DCI |
| Domain | RS | configured | (PUCCH) | |
| Behavior of | | | DCI (PUSCH) | |
| Resource | SP CSI-RS | Not | MAC CE | DCI |
| Setting | | Supported | (PUCCH) | |
| | | | DCI (PUSCH) | |
| | AP CSI-RS | Not | Not | DCI |
| | | Supported | Supported | |

Also, associated resource settings for a CSI Report Setting have a same time domain behavior, periodic CSI-RS/IM resource and CSI reports are always assumed to be present and active once configured by RRC, aperiodic and semi-persistent CSI-RS/IM resources and CSI reports need to be explicitly triggered or activated, aperiodic CSI-RS/IM resources and aperiodic CSI reports, the triggering is done jointly by transmitting a DCI Format 0-1, and semi-persistent CSI-RS/IM resources and semi-persistent CSI reports are independently activated.

For aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC. An aperiodic trigger state in turn is defined as a list of up to 16 aperiodic CSI Report Settings, identified by a CSI Report Setting ID for which the UE calculates simultaneously CSI and transmits it on the scheduled PUSCH transmission. When the CSI Report Setting is linked with aperiodic Resource Setting (can comprise multiple Resource Sets), the aperiodic NZP CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the QCL source to use is also configured in the aperiodic trigger state. The UE 104 assumes that the resources used for the computation of the channel and interference can be processed with the same spatial filter (e.g., quasi-co-located with respect to “QCL-TypeD”).

For aperiodic CSI reporting, PUSCH-based reports are divided into two CSI parts: CSI Part 1 and CSI Part 2. The size of CSI payload may vary significantly, and therefore a worst-case UCI payload size design would result in large overhead. CSI Part 1 has a fixed payload size (and can be decoded by the gNB without prior information) and contains the following: RI (if reported), CRI (if reported) and CQI for the first codeword, and number of non-zero wideband amplitude coefficients per layer for Type II CSI feedback on PUSCH. CSI Part 2 has a variable payload size that can be derived from the CSI parameters in CSI Part 1 and contains PMI and the CQI for the second codeword when RI>4.

For example, if the aperiodic trigger state indicated by DCI format 0_1 defines 3 report settings x, y, and z, then the aperiodic CSI reporting for CSI part 2 will be ordered as in various priorities. As described herein, CSI reports are prioritized according to:
time-domain behavior and physical channel, where more dynamic reports are given precedence over less dynamic reports and PUSCH has precedence over PUCCH;
CSI content, where beam reports (i.e., L1-RSRP reporting) has priority over regular CSI reports; the serving cell to which the CSI corresponds (in case of CA operation). CSI corresponding to the PCell has priority over CSI corresponding to Scells; and
the reportConfigID.

### Codebook Subset Restriction

Codebook Subset Restriction (CBSR) is supported for Release 15 Type-I and Type-II CSI for controlling inter-cell interference levels. In Type-I CBSR, a size N₁N₂O₁O₂ bitmap is used to indicate the restricted beam, where N₁/N₂ and O₁/O₂ indicate the number of horizontal/vertical ports and horizontal/vertical oversampling factors, respectively. Each bit in the sequence is used to restrict a certain DFT beam for a given oversampling index. The bitmap parameter typeI-SinglePanel-codebookSubsetRestriction-i2 forms the bit sequence b₁₅, . . . , b₁, b₀ where b₀ is the LSB and b₁₅ is the MSB. The bit bᵢ is associated with precoders corresponding to codebook index i₂=i. When bᵢ is zero, the randomly selected precoder for CQI calculation is not allowed to correspond to any precoder associated with the bit bᵢ.

In Type-II CBSR, instead of a hard restriction decision, i.e., a DFT beam within an oversampling index is either fully prohibited or unrestrictedly available, an amplitude restriction is further imposed as follows:

The N₁N₂O₁O₂ candidate DFT beams are re-grouped into O₁O₂ beam groups (beams within a beam group do not necessarily belong to the same oversampling index);

Beam restriction is only allowed on 4 out of the O₁O₂ beam groups, i.e.,

$$⌈ {log}_{2} {C}_{4}^{{O}_{1} {O}_{2}} ⌉$$

For the 4N₁N₂ restricted beams across the 4 beam groups, 2 bits are allocated per beam to indicate the restriction on the maximum allowed amplitude value from a codebook of amplitude value restrictions, wherein the amplitude restriction,

$$A m p . = \{ 1 , {( \frac{1}{2} )}^{\frac{1}{2}} , {( \frac{1}{4} )}^{\frac{1}{2}} , 0 \} , i . e . , - 3 dB$$

step size per restriction value in power domain. Hence, 8N₁N₂ bits are required to report the amplitude restrictions for the 4 restricted beam groups based on Type-II soft restriction.

The bitmap parameter n1-n2-codebookSubsetRestriction-r16 forms the bit sequence B=B₁B₂ and configures the vector group indices g^{(k)} as in clause 5.2.2.2.3. Bits

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$$

indicate the maximum allowed average amplitude, γ_{i+pL} (p=0,1), with i∈{0, 1, . . . , L−1} corresponding to a beam index, of the coefficients associated with the vector in group g^{(k)} indexed by x₁, x₂, where the maximum amplitudes are given in Table 2 and the average coefficient amplitude is restricted as follows:

$$\sqrt{\frac{1}{{\sum }_{f = 0}^{{M}_{υ - 1}} {k}_{l , i + pL , f}^{( 3 )}} {\sum }_{f = 0}^{{M}_{υ} - 1} {{k}_{l , i + pL , f}^{( 3 )} ( {p}_{l , p}^{( 1 )} {p}_{l , i + pL , f}^{( 2 )} )}^{2}} \leq {γ}_{i + p L}$$

for l=1, . . . , v, is a layer index, f∈{0, 1, . . . , Mᵥ−1} is a frequency-domain basis index, and p=0,1 is a polarization index. A UE that does not report the parameter softAmpRestriction-r16=‘supported’ in its capability signaling is not expected to be configured with

$${b}_{2}^{( k , 2 ( {N}_{1} {x}_{2} + {x}_{1} ) + 1 )} {b}_{2}^{( k , 2 ( {N}_{1} {x}_{2} + {x}_{1} ) )} = 01 or 10.$$

Table 2 depicts a Maximum allowed average coefficient amplitudes for restricted vectors:

TABLE 2

| Bit | Maximum |
|---|---|
| ${b}_{2}^{( k , 2 ( {N}_{1} {x}_{2} + {x}_{1} ) + 1 )} {b}_{2}^{( k , 2 ( {N}_{1} {x}_{2} + {x}_{1} ) )}$ | Average Coefficient Amplitude γ_{i+pL} |
| 00 | 0 |
| 01 | \sqrt{1/4} |
| 10 | \sqrt{1/2} |
| 11 | 1 |

### Spatial Domain Enhancements

As described herein, a network may support and/or employ spatial domain adaptation. For type 1, antenna port adaptation includes a different subset of ports of a CSI-RS resource are selected for different spatial adaptation patterns, corresponding to CSI reporting sub-configurations, to enable comparison of channel quality via CSI reporting of two sub-reports. For example, 4 CSI sub-configurations (bitmaps) may be associated with four antenna patterns.

For type 2, antenna element adaptation includes Different antenna elements being selected per CSI-RS port corresponding to different CSI reporting sub-configurations (e.g., with a same CSI-RS port number and layout, to enable comparison of channel quality via CSI reporting of two sub-reports. For example, 2 CSI sub-configurations (e.g., different CSI-RS resources) may be associated with two antenna patterns.

For both types, the UE 104 may be configured with multiple sub-configurations, each of which are associated with separate CSI calculations and separate CSI reporting in the form of multiple CSI sub-reports, each computed separately. Note that different sub-configurations may also be based on separate CSI-RS transmissions.

Antenna Panels Ports, [symbol] uasi-collocation, TCI States, Spatial Relations

In some embodiments, the terms antenna, panel, and antenna panel may be used interchangeably. An antenna panel may be hardware that is used for transmitting and/or receiving radio signals at frequencies lower than 6 GHz, e.g., frequency range 1 (FR1), or higher than 6 GHZ, e.g., frequency range 2 (FR2), or millimeter wave (mmWave). In some cases, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some cases, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some cases, capability information may be communicated via signaling or, in some cases, capability information may be provided to devices without a need for signaling. When such information is available to other devices, it can be used for signaling or local decision making.

In some cases, a device (e.g., UE, node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some cases, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to a gNB. For certain conditions, the gNB or network can assume the mapping between device's physical antennas to the logical entity “device panel” may not be changed. For example, the condition may include until the next update or report from device or comprise a duration of time over which the gNB assumes there will be no change to the mapping. A device may report its capability with respect to the “device panel” to the gNB or network. The device capability may include at least the number of “device panels.” In some cases, the device may support UL transmission from one beam within a panel; with multiple panels, more than one beam (one beam per panel) may be used for UL transmission. In some cases, more than one beam per panel may be supported/used for UL transmission.

In some of cases, an antenna port is defined such that the channel over which a symbol on the antenna port is conveyed can be inferred from the channel over which another symbol on the same antenna port is conveyed. Two antenna ports are quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation, and so on. The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE 104 may not be able to perform omni-directional transmission, e.g., the UE 104 would need to form beams for directional transmission. A QCL-TypeD between two reference signals A and B, the reference signal A is considered to be spatially co-located with reference signal B and the UE 104 may assume that the reference signals A and B can be received with the same spatial filter (e.g., with the same RX beamforming weights).

An “antenna port” may be a logical port that may correspond to a beam (resulting from beamforming) or may correspond to a physical antenna on a device. In some cases, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some cases, a Transmission Configuration Indication (TCI) state associated with a target transmission can indicate parameters for configuring a quasi-collocation relationship between the target transmission (e.g., target RS of DM-RS ports of the target transmission during a transmission occasion) and a source reference signals (e.g., SSB/CSI-RS/SRS) with respect to quasi co-location type parameters indicated in the corresponding TCI state. The TCI describes the reference signals are used as QCL source, and what QCL properties can be derived from each reference signal. A device can receive a configuration of a plurality of transmission configuration indicator states for a serving cell for transmissions on the serving cell. In some cases, a TCI state comprises at least one source RS to provide a reference (UE assumption) for determining QCL and/or spatial filter.

In some cases, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some cases, a UL TCI state is provided if a device is configured with separate DL/UL TCI by RRC signaling. The UL TCI state may comprise a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some cases, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

### CSI Measurement and Reporting for Multiple Spatial Domain Adaptations

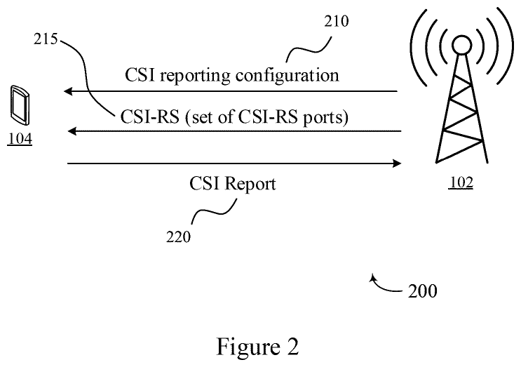

As described herein, a UE (e.g., the UE 104) may be configured by the network to perform CSI measurement and/or reporting for multiple spatial domain adaptation patterns employed by the network. In order to inform the UE 104 about the adaptation patterns, such as the antenna port adaptation, the UE 104 may be configured with a CSI reporting configuration, or configuration for CSI reporting, that enables selection by the UE 104 of a subset of ports. FIG. 2 illustrates an example block diagram that depicts communications between the UE 104 and the NE 102 in accordance with aspects of the present disclosure.

The NE 102 (e.g., a base station) transmits a CSI reporting configuration 210 to the UE 104. As described herein, the CSI reporting configuration 210 may instruct and/or configure the UE 104 to determine (e.g., compute or measure) a full CSI for a set of ports, a partial CSI for a configured subset of ports, and/or a partial CSI for a UE-selected subset of ports.

The NE 102 may transmit a CSI-RS 215, which includes an indication of a set of CSI-RS ports, including various subsets of CSI-RS ports associated with different spatial domain adaptation patterns employed by the NE 102. In response to receiving the CSI-RS 215, the UE 104 measures the CSI and transmits a CSI report 220 to the NE 102.

In some embodiments, the UE 104 is configured with a CSI report setting. The CSI report setting is associated with a CSI-RS resource setting comprising one or more NZP CSI-RS resources, where the one or more NZP CSI-RS resources constitute multiple NZP CSI-RS ports. In some case, a total number of antenna ports is equal to the total number of NZP CSI-RS ports associated with the one or more NZP CSI-RS resources. In some cases, all NZP CSI-RS resources of the one or more NZP CSI-RS resources are equipped with a same number of NZP CSI-RS ports. In some cases, an ordering of the antenna ports is based on a respective ordering of the NZP CSI-RS port indices of each NZP CSI-RS resource, e.g., assuming K NZP CSI-RS resources of P NZP CSI-RS ports each, an indexing of the antenna ports is in the order of all P NZP CSI-RS ports of the first NZP CSI-RS resource, followed by all P NZP CSI-RS ports of the second NZP CSI-RS resource, and so on, and ending with all P NZP CSI-RS ports of the last NZP CSI-RS resource.

In some embodiments, the CSI reporting configuration 210 configures the UE 104 to report at least one of: a first PMI value corresponding to all antenna ports, a second PMI value corresponding to a subset of the antenna ports, a first CQI value associated with the first PMI value corresponding to all antenna ports, a second CQI associated with the second PMI value corresponding to the subset of the antenna ports, a first RI value associated with the first PMI value corresponding to all antenna ports, and/or a second PMI value associated with the second PMI value corresponding to the subset of the antenna ports.

In some cases, the second PMI value is inferred from the first PMI value, e.g., parameters corresponding to the second PMI value are a subset of parameters of the first PMI value. In some cases, the first RI value and the second RI value are configured to be the same value. In some cases, the second RI value is no larger than the first RI value. In some cases, the second CQI value corresponds to a differential value with respect to the first CQI value. In some cases, the second CQI value is no larger than the first CQI value, conditioned that the first RI value and the second RI value are configured to be equal.

In some embodiments, the UE 104 may be configured to perform CSI reporting for a subset of the N ports, where the subset is a fraction of the N ports (e.g., N/α ports, wherein Nis divisible by α). Thus, the subset may be an outcome of a division of a value N by a that is an integer value that is no larger than N.

In some cases, the value of α is in a form of 2^{μ} for μ=01, 2, . . . log(N)−1. In some cases, the N ports may be decomposed to N₁ and N₂ ports associated with two dimensions, such that N=N₁N₂, where α₁, α₂ are two integer-valued port selection factors for the N1 and N2 ports, respectively, such that α=α₁α₂, and N₁ is divisible by α₁, and N₂ is divisible by α₂. For example, two dimensions may correspond to two spatial dimensions, two coordinate systems in space, a vertical and horizontal layout of an antenna panel, or a combination thereof. The layout (e.g., a layout of CSI-RS ports) may corresponds to a number of the CSI-RS ports, a distribution of the CSI-RS ports over one or more dimensions, a spacing between two consecutive CSI-RS ports of the CSI-RS ports, or a combination thereof.

In some cases, there may be a gap (e.g., a uniform gap) between CSI-RS ports. A uniform gap may comprise or correspond to a fixed value of difference in index values of each CSI-RS port and a subsequent CSI-RS port, a fixed geometrical spacing between each CSI-RS port and a subsequent CSI-RS port over at least one dimension, or a combination thereof. Further, uniform gaps between identifiers of each column and subsequent columns may correspond to a fixed value of difference in index values of each column and the subsequent column, where the difference may be based on a modulo operation with respect to a total number of CSI-RS ports in the set of CSI-RS ports.

In some cases, an indication of a selection of the N/a ports is selected by the UE 104 or assisted by the UE 104 based on a network configuration. In some cases, an indication of a selection of the N/a ports is based on a network configuration.

In some embodiments, the UE 104 may be configured to perform CSI reporting for a subset of the N ports, where the subset is a fraction of the N ports (e.g., BN ports, wherein β<1, and BN is a positive integer value). In some cases, the value of β is in a form of 2^{-μ} for μ=01,2, . . . log(N)−1. In some cases, the N ports are decomposed to N₁ and N₂ ports associated with two dimensions, such that N=N₁N₂, and wherein β₁, β₂ are two integer-valued port selection factors for the N1 and N2 ports, respectively, such that β=B₁β₂, and both β₁N₁, and β₂N₂ are positive integer values. In some cases, an indication of a selection of the BN ports is selected by the UE 104 or assisted by the UE 104 based on a network configuration. In some cases, an indication of a selection of the BN ports is based on a network configuration.

In some embodiments, the UE 104 may be configured with a CQI threshold value, where a delta value corresponding to a difference of a first CQI value associated with the N ports and a second CQI value associated with a selected subset of the N ports is no larger than the CQI threshold value. In some cases, the UE 104 reports CSI report quantities (e.g., PMI, RI, CQI) associated with the selected subset of the N ports if the delta value is within the CQI threshold value. In some cases, the UE 104 reports the CSI report quantities if the delta value is within the CQI threshold value, if the delta value is larger than the CQI threshold value, or if the delta value is larger than the CQI threshold value. In some cases, the delta value is computed assuming a first RI value associated with the N ports and a second RI value associated with the selected subset of the N ports are equal. In some cases, the UE 104 selects the subset of the N ports. In some cases, the selected subset of the N ports is configured by the network via a higher layer RRC message, a field in a MAC CE, a field in DCI, and so on.

In some embodiments, the UE 104 is configured with an RI threshold value, wherein a delta value corresponding to a difference of a first RI value associated with the N ports and a second RI value associated with a selected subset of the N ports is no larger than the RI threshold value. In some cases, the UE 104 reports the CSI report quantities if the delta value is within the RI threshold value. In some cases, the UE 104 reports the CSI report quantities if the delta value is within the RI threshold value, if the delta value is larger than the RI threshold value, or if the delta value is larger than the RI threshold value. In some cases, the delta value is computed assuming a first RI value associated with the N ports and a second RI value associated with the selected subset of the N ports are equal. In some cases, the UE 104 selects the subset of the N ports. In some cases, the selected subset of the N ports is configured by the network via one of a higher layer RRC message, a field in a MAC CE, a field in DCI, and so on.

In some embodiments, to indicate a selected subset of antenna ports (or a corresponding set of DFT columns constituting the PMI), a specified format to indicate the ports, as well as the codebooks, is determined.

First, however, are details analyzing DFT matrix properties. A DFT matrix F of size N takes on the form:

$${F}_{N} = \frac{1}{\sqrt{N}} [ \begin{matrix}1 & 1 & 1 & 1 & … & 1 \\ 1 & ω & {ω}^{2} & {ω}^{3} & … & {ω}^{N - 1} \\ 1 & {ω}^{2} & {ω}^{4} & {ω}^{6} & … & {ω}^{2 ( N - 1 )} \\ 1 & {ω}^{3} & {ω}^{6} & {ω}^{9} & … & {ω}^{3 ( N - 1 )} \\ ⋮ & ⋮ & ⋮ & ⋮ & ⋱ & ⋮ \\ 1 & {ω}^{N - 1} & {ω}^{2 ( N - 1 )} & {ω}^{3 ( N - 1 )} & … & {ω}^{( N - 1 ) ( N - 1 )}\end{matrix} ]$$

Where ω≙e^{2πj/N}. For instance, for N=8, F₈ is as follows:

$${F}_{8} = \frac{1}{\sqrt{8}} [ \begin{matrix}1 & 1 & 1 & 1 & 1 & 1 & 1 & 1 \\ 1 & ω & {ω}^{2} & {ω}^{3} & {ω}^{4} & {ω}^{5} & {ω}^{6} & {ω}^{7} \\ 1 & {ω}^{2} & {ω}^{4} & {ω}^{6} & {ω}^{8} & {ω}^{10} & {ω}^{12} & {ω}^{14} \\ 1 & {ω}^{3} & {ω}^{6} & {ω}^{9} & {ω}^{12} & {ω}^{15} & {ω}^{18} & {ω}^{21} \\ 1 & {ω}^{4} & {ω}^{8} & {ω}^{12} & {ω}^{16} & {ω}^{20} & {ω}^{24} & {ω}^{28} \\ 1 & {ω}^{5} & {ω}^{10} & {ω}^{15} & {ω}^{20} & {ω}^{25} & {ω}^{30} & {ω}^{35} \\ 1 & {ω}^{6} & {ω}^{12} & {ω}^{18} & {ω}^{24} & {ω}^{30} & {ω}^{36} & {ω}^{42} \\ 1 & {ω}^{7} & {ω}^{14} & {ω}^{21} & {ω}^{28} & {ω}^{35} & {ω}^{42} & {ω}^{49}\end{matrix} ]$$

Following a first proposition (Proposition 1), a size N DFT matrix that is sub-sampled such that alternating N/2 rows are selected, and any N/2 consecutive columns are selected, is a size N/2 orthonormal matrix. For example, for

$${[ {F}_{N} ]}_{k , l} = \frac{1}{\sqrt{N}} exp ( j \frac{2 π k l}{N} )$$

Let gₗ correspond to an l^{th} column vector of a sub-sampled matrix [symbol] , based on selecting a subset of the N rows of F_{N}, wherein the set of selected rows belong to set [symbol] , i.e., The matrix [symbol] is | [symbol] |×| [symbol] |, where | [symbol] |<N. A check of the orthogonality of matrix [symbol] can be done via computing the inner product of any two columns gᵢ_{ₗ}, and gᵢ_{ₗ}, where l′≠l, i.e.,

$${g}_{{i}_{l}}^{H} {g}_{{i}_{{l}^{′}}} = \frac{1}{N} exp ( j \frac{2 π k}{N} ( l - {l}^{′} ) ) ,$$

Where the result is zero for an orthonormal matrix. For a case where

$$\vert \vert = N / 2 , k = 0 , 2 , … , N - 2 , and l - {l}^{′} ∈ \{ - \frac{N}{2} + 1 , … , - 1 , 1 , … , \frac{N}{2} - 1 \} . Note that l - {l}^{′} \neq 0$$

$${g}_{{i}_{{l}^{′}}}^{H} {g}_{{i}_{l}} = \frac{1}{N} {\sum }_{k = 0 , 2 , … , N - 2} exp ( j \frac{2 π k}{N} ( l - {l}^{′} ) )$$

$$Define m = k / 2.$$

$${g}_{{i}_{{l}^{′}}}^{H} {g}_{{i}_{l}} = \frac{1}{N} {\sum }_{m = 0 , 1 , … , \frac{N}{2} - 1} exp ( j \frac{2 π m}{N / 2} ( l - {l}^{′} ) )$$

$$If ( l - {l}^{′} ) ∈ \{ - \frac{N}{2} + 1 , … , - 1 , 1 , … , \frac{N}{2} - 1 \} ,$$

then the summation is equal to zero. Equivalently, for any selection of N/2 consecutive columns (the consecution can be circular), the resulting sub-matrix is orthonormal. Similarly, if we assume k=1, 3, . . . , N−1, then:

$${g}_{{i}_{{l}^{′}}}^{H} {g}_{{i}_{l}} = \frac{1}{N} {\sum }_{k = 1 , 3 , … , N - 1} exp ( j \frac{2 π k}{N} ( l - {l}^{′} ) )$$

$$Define m = ( k - 1 ) / 2.$$

$${g}_{{i}_{{l}^{′}}}^{H} {g}_{{i}_{l}} = \frac{1}{N} exp ( j \frac{2 π}{N} ( l - {l}^{′} ) ) {\sum }_{m = 0 , 1 , … , \frac{N}{2} - 1} exp ( j \frac{2 π m}{N / 2} ( l - {l}^{′} ) )$$

This is again equal to zero if

$$( l - {l}^{′} ) ∈ \{ - \frac{N}{2} + 1 , … , - 1 , 1 , … , \frac{N}{2} - 1 \} .$$

The combination of these two cases, proves the proposition. For example, the bold entries correspond to a 4×4 sub-selection of F₈ that maintains orthonormality.

$${F}_{8} = \frac{1}{\sqrt{8}} [ \begin{matrix}1 & 1 & 1 & 1 & 1 & 1 & 1 & 1 \\ 1 & ω & {ω}^{2} & {ω}^{3} & {ω}^{4} & {ω}^{5} & {ω}^{6} & {ω}^{7} \\ 1 & {ω}^{2} & {ω}^{4} & {ω}^{6} & {ω}^{8} & {ω}^{10} & {ω}^{12} & {ω}^{14} \\ 1 & {ω}^{3} & {ω}^{6} & {ω}^{9} & {ω}^{12} & {ω}^{15} & {ω}^{18} & {ω}^{21} \\ 1 & {ω}^{4} & {ω}^{8} & {ω}^{12} & {ω}^{16} & {ω}^{20} & {ω}^{24} & {ω}^{28} \\ 1 & {ω}^{5} & {ω}^{10} & {ω}^{15} & {ω}^{20} & {ω}^{25} & {ω}^{30} & {ω}^{35} \\ 1 & {ω}^{6} & {ω}^{12} & {ω}^{18} & {ω}^{24} & {ω}^{30} & {ω}^{36} & {ω}^{42} \\ 1 & {ω}^{7} & {ω}^{14} & {ω}^{21} & {ω}^{28} & {ω}^{35} & {ω}^{42} & {ω}^{49}\end{matrix} ]$$

Following a second proposition (Proposition 2), a size N DFT matrix that is sub-sampled such that any N/2 consecutive rows are selected, and alternating columns are selected, is a size N/2 matrix whose columns are orthonormal. For example:

$$In case of \vert \vert = N / 2 , k = 0 , 1 , … , N / 2 - 1 , and l - {l}^{′} ∈ \{ - N + 2 , … , - 2 , 2 , … , N - 2 \} . Note that l - {l}^{′} \neq 0$$

$${g}_{{i}_{{l}^{′}}}^{H} {g}_{{i}_{l}} = \frac{1}{N} {\sum }_{k = 0 , … , N / 2 - 1} exp ( j \frac{2 π k}{N} ( l - {l}^{′} ) )$$

$$Define f = l / 2 , {f}^{′} = {l}^{′} / 2.$$

$${g}_{{i}_{{f}^{′}}}^{H} {g}_{{i}_{f}} = \frac{1}{N} {\sum }_{k = 0 , … , N / 2 - 1} exp ( j \frac{2 π m}{N / 2} ( f - {f}^{′} ) )$$

$$When k = α , α + 1 , … , α + N / 2 - 1. Let m = k - α$$

$${g}_{{i}_{{f}^{′}}}^{H} {g}_{{i}_{f}} = \frac{1}{N} exp ( j \frac{2 π α}{N / 2} ( f - {f}^{′} ) ) {\sum }_{m = 0 , 1 , … , N / 2 - 1} exp ( j \frac{2 π m}{N / 2} ( f - {f}^{′} ) )$$

This is equal to zero, for any choice of [symbol] as N/2 consecutive integers in {0, 1, . . . , N}. Note that this holds also for circular consecutions. The result holds whenever l−l′∈{−N+2, . . . , −2,2, . . . , N−2} which proves the proposition. For example, the bold entries correspond to a 4×4 sub-selection of F₈ that maintains orthonormality:

$${F}_{8} = \frac{1}{\sqrt{8}} [ \begin{matrix}1 & 1 & 1 & 1 & 1 & 1 & 1 & 1 \\ 1 & ω & {ω}^{2} & {ω}^{3} & {ω}^{4} & {ω}^{5} & {ω}^{6} & {ω}^{7} \\ 1 & {ω}^{2} & {ω}^{4} & {ω}^{6} & {ω}^{8} & {ω}^{10} & {ω}^{12} & {ω}^{14} \\ 1 & {ω}^{3} & {ω}^{6} & {ω}^{9} & {ω}^{12} & {ω}^{15} & {ω}^{18} & {ω}^{21} \\ 1 & {ω}^{4} & {ω}^{8} & {ω}^{12} & {ω}^{16} & {ω}^{20} & {ω}^{24} & {ω}^{28} \\ 1 & {ω}^{5} & {ω}^{10} & {ω}^{15} & {ω}^{20} & {ω}^{25} & {ω}^{30} & {ω}^{35} \\ 1 & {ω}^{6} & {ω}^{12} & {ω}^{18} & {ω}^{24} & {ω}^{30} & {ω}^{36} & {ω}^{42} \\ 1 & {ω}^{7} & {ω}^{14} & {ω}^{21} & {ω}^{28} & {ω}^{35} & {ω}^{42} & {ω}^{49}\end{matrix} ]$$

Based on the second proposition, given a set of N DFT columns, a subset of N/2 columns can remain orthogonal if there are N/2 consecutive samples of their elements or alternating samples of their elements. For example, assume a 32 port antenna, whose DFT codebook is of size 32, and assume monotonic ordering of ports with respect to index of a ULA. A DFT codebook is [w₁, w₂, . . . , w₃₂] comprising 32 vectors, where wₖ is a vector of length 32, and a new set (Set 1) of codebooks can be designed for 16 ports with even ID, i.e., p₀, p₂, . . . , p₃₀, (16 ports), which is in the form {w′_{β+1} w′_{β+2} . . . W′_{β+16}}, where a is of any value from 1, . . . , 16, i.e., a total of 16 possible codebooks, and w′ₖ is a vector of length 16. This approach provides more flexibility in codebook selection given limitation in port sub-selection. Same applies for a sub-selection of 16 ports with odd ID, i.e., p₁, p₃, . . . , p₃₁.

For β=0,1, i.e., for either an even or odd set of ports, 0.5N+1 CBs can be configured per port layout. The selection of N/α antenna ports over one dimension may be interpreted as follows. For a DFT-based matrix B comprising N columns, i.e., Bis an N×N DFT matrix, the selection is as follows:

$$\tilde{B} = P \cdot B \cdot {S}^{T}$$

Both P and S are (N/α)×N selection matrices, comprised of standard unit vector rows, i.e., a vector eₖ is a column vector of a value 1 at the kth entry, whereas a remainder of entries are of value:

$$\begin{matrix}P = {α}^{1 / 4} \cdot {[ \begin{matrix}{e}_{δ + 1} & {e}_{δ + 2} & … & {e}_{δ + \frac{N}{α}}\end{matrix} ]}^{T} , \\ S = {α}^{1 / 4} \cdot {[ \begin{matrix}{e}_{β + 1} & {e}_{β + α + 1} & … & {e}_{β + N - α + 1}\end{matrix} ]}^{T} , \\ Alternatively , \\ P = {α}^{1 / 4} \cdot {[ \begin{matrix}{e}_{δ + α + 1} & {e}_{δ + α + 2} & … & {e}_{δ + N - α + 1}\end{matrix} ]}^{T} , \\ S = {α}^{1 / 4} \cdot {[ \begin{matrix}{e}_{β + 1} & {e}_{β + 2} & … & {e}_{β + \frac{N}{α}}\end{matrix} ]}^{T} .\end{matrix}$$

Another set (Set 2) of codebooks can be designed for any 16 consecutive ports, i.e., p_{δ}, p_{δ+1}, . . . , p_{δ+15}, where δ varies from 0 to 16, which is [w′_{β+1} w′_{β+3} . . . w′_{β+15}], where α is either 0 or 1, i.e., a total of 2 possible codebooks for each of the 0.5N+1 port selection combinations. This approach provides more flexibility in port selection at the expense of a limitation in codebook selection.

Considering the aggregation of both Set 1 and Set 2 codebooks, the total number of possible codebooks is 2N+4. Further, the previous proposition can be extended to any sub-selection of a DFT matrix, as long as the size of the sub-selected matrix is divisible by the size of the original DFT matrix.

Following a third proposition (Proposition 3), a size N DFT matrix that is sub-sampled such that any N/a rows whose difference in index values are integer multiples of a are selected, and any N/a consecutive columns are selected, is a size N/a matrix whose columns are orthonormal, conditioned that Nis divisible by a. For example:

$${[ {F}_{N} ]}_{k , l} = \frac{1}{\sqrt{N}} exp ( - j \frac{2 π k l}{N} )$$

$${g}_{{i}_{l}}^{H} {g}_{{i}_{{l}^{′}}} = \frac{1}{N} exp ( j \frac{2 π k}{N} ( l - {l}^{′} ) )$$

$$In case of \vert \vert = N / α , k = δ , δ + α , … , N + δ - α , and l - {l}^{′} ∈ \{ - \frac{N}{a} + 1 , … , - 1 , 1 , … , \frac{N}{a} - 1 \} , and δ = 0 , 1 , … , α - 1. Note that l - {l}^{′} \neq 0.$$

$${g}_{{i}_{l}}^{H} {g}_{{i}_{{l}^{′}}} = \frac{1}{N} {\sum }_{k = δ , δ + a , … , N + δ - a} exp ( j \frac{2 π k}{N} ( l - {l}^{′} ) )$$

$$Define m = ( k - δ ) / α .$$

$${g}_{{i}_{l}}^{H} {g}_{{i}_{{l}^{′}}} = \frac{1}{N} exp ( j \frac{2 π δ}{N} ( l - {l}^{′} ) ) {\sum }_{m = 0 , 1 , … , \frac{N}{𝒶} - 1} exp ( j \frac{2 π m}{N / α} ( l - {l}^{′} ) )$$

Note the summation goes to zero, similar to that of an N/a size DFT.

Following a fourth proposition (Proposition 4), a size N DFT matrix that is sub-sampled such that any N/a consecutive rows are selected, and any N/a columns whose difference in index values are integer multiples of a are selected, is a size N/a matrix whose columns are orthonormal, conditioned that Nis divisible by a. For example, in case of | [symbol] |=N/α, k=δ,δ+1, . . . , δ+N/α−1, and l-l′∈{−N+α, . . . , −α, α, . . . , N−α}, and δ=0,1, . . . , α−1. Similar to the previous proof, l-l′≠0.

$$\begin{matrix}{g}_{{i}_{l}}^{H} {g}_{{i}_{{l}^{′}}} = \frac{1}{N} {\sum }_{k = δ , δ + 1 , … , δ + N / α - 1} exp ( j \frac{2 π k}{N} ( l - {l}^{′} ) ) \\ Define f = l / α , {f}^{′} = {l}^{′} / α , and m = k - δ \\ {g}_{{i}_{f}}^{H} {g}_{{i}_{{f}^{′}}} = \frac{1}{N} exp ( j \frac{2 π δ}{N / α} ( f - {f}^{′} ) ) {\sum }_{m = 0 , … , N / α - 1} exp ( j \frac{2 π m}{N / α} ( f - {f}^{′} ) )\end{matrix}$$

Note the summation also goes to zero, similar to that of an N/α size DFT. Thus, a step a sub-sampling of a set of orthonormal columns can be useful.

Following a fifth proposition (Proposition 5), a size N DFT matrix that is sub-sampled such that any N/α rows whose difference in index values are integer multiples of a are selected, and any N/α consecutive columns are selected considering modulo-N indexing of the columns, i.e., columns β,

$$m o {d}_{N} ( β + 1 ) , m o {d}_{N} ( β + 2 ) , … , {mod}_{N} ( β + \frac{N}{α} - 1 ) ,$$

the sub-sampled matrix of size N/α is orthonormal for β=0,1, . . . , N−1, conditioned that N is divisible by α. For example,

$$\begin{matrix}{[ {F}_{N} ]}_{k , l} = \frac{1}{\sqrt{N}} exp ( - j \frac{2 π k l}{N} ) \\ {g}_{{i}_{l}}^{H} {g}_{{i}_{{l}^{′}}} = \frac{1}{N} exp ( j \frac{2 π k}{N} ( l - {l}^{′} ) )\end{matrix}$$

For | [symbol] |=N/α, and k=δ, δ+α, . . . , N+δ−α, where δ=0, 1, . . . , α−1, we aim at proving that for a set of column indices β, (β+1)mod N, (β+2)mod N, . . . ,

$$( β + \frac{N}{α} - 1 ) mod N ,$$

the reduced matrix is orthonormal for a case where β+γ>N−1 for some

$$γ \leq \frac{N}{α} - 1 ,$$

or equivalently for

$$β > ( 1 - \frac{1}{α} ) N .$$

Given Proposition 3,

$${g}_{{i}_{l}}^{H} {g}_{{i}_{{l}^{′}}} = \frac{1}{N} {\sum }_{k = {δ}_{,} δ + a , … , N + δ - a} exp ( j \frac{2 π k}{N} ( l - {l}^{′} ) ) = 0 for all l , \text{} {l}^{′} ∈ \text{} \{ β , β + 1 , … , β + \frac{N}{α} - 1 \} < N , and l \neq {l}^{′}$$

Assume the following set of N/α column indices are considered:

$$\{ β , β + 1 , … , N - 1 , 0 , 1 , … , \frac{N}{α} - 1 - ( N - β ) \} .$$

The corresponding N/α column vectors of an N-dimensional DFT matrix

$${F}_{N} are \{ {f}_{β} , … , {f}_{N - 1} , {f}_{0} , {f}_{1} , … , {f}_{\frac{N}{α} 1 - ( N - β )} \} .$$

For an N-dimensional column vector of a DFT matrix f_{σ}, it can be shown that f_{σ}=f_{σ+N}, and hence the N/α column vectors of F_{N} can be represented by as

$$\{ {f}_{β} , … , {f}_{N - 1} , {f}_{N} , {f}_{N + 1} , … , {f}_{\frac{N}{α} 1 + β} \} ,$$

where the range of cross correlation indices difference over the set of vectors is

$$l - {l}^{′} ∈ \{ - \frac{N}{α} + 1 , … , - 1 , 1 , … , \frac{N}{α} - 1 \} ,$$

similar to Proposition 3.
Therefore, the summation:

$${g}_{{i}_{l}}^{H} {g}_{{i}_{{l}^{′}}} = \frac{1}{N} {\sum }_{k ∈ 𝒦} exp ( j \frac{2 π k}{N} ( l - {l}^{′} ) )$$

goes to zero for

$$β > ( 1 - \frac{1}{α} ) N .$$

For example, the bold entries correspond to a 4×4 sub-selection of F₈ that maintains orthonormality:

$${F}_{8} = \frac{1}{\sqrt{8}} [ \begin{matrix}1 & 1 & 1 & 1 & 1 & 1 & 1 & 1 \\ 1 & ω & {ω}^{2} & {ω}^{3} & {ω}^{4} & {ω}^{5} & {ω}^{6} & {ω}^{7} \\ 1 & {ω}^{2} & {ω}^{4} & {ω}^{6} & {ω}^{8} & {ω}^{10} & {ω}^{12} & {ω}^{14} \\ 1 & {ω}^{3} & {ω}^{6} & {ω}^{9} & {ω}^{12} & {ω}^{15} & {ω}^{18} & {ω}^{21} \\ 1 & {ω}^{4} & {ω}^{8} & {ω}^{12} & {ω}^{16} & {ω}^{20} & {ω}^{24} & {ω}^{28} \\ 1 & {ω}^{5} & {ω}^{10} & {ω}^{15} & {ω}^{20} & {ω}^{25} & {ω}^{30} & {ω}^{35} \\ 1 & {ω}^{6} & {ω}^{12} & {ω}^{18} & {ω}^{24} & {ω}^{30} & {ω}^{36} & {ω}^{42} \\ 1 & {ω}^{7} & {ω}^{14} & {ω}^{21} & {ω}^{28} & {ω}^{35} & {ω}^{42} & {ω}^{49}\end{matrix} ]$$

As an example, assume an N port antenna, whose DFT codebook is of size N, and assume monotonic ordering of ports with respect to index of a ULA. A DFT codebook is [w₁, w₂, . . . , w_{N}] comprising N vectors, where wₖ is a vector of length N. A new set (Set 1) of codebooks can be designed for N/α ports with selecting every α port, i.e., p_{δ}, p_{δ+α}, p_{δ+2α}, . . . , p_{δ+ (N/α-1)α}, (N/α ports), here δ=0, 1, . . . , α−1, which is in the form {w′_{β+1} w′_{β+2} . . . w′_{β+N/α}}, where β is of any value from

$$0 , … , N ( 1 - \frac{1}{α} ) , i . e . ,$$

a total of

$$N ( 1 - \frac{1}{α} ) + 1$$

possible codebooks, and w′ₖ is a vector of length N/α. This approach provides more flexibility in codebook selection given limitation in port sub-selection.

Also, for an arbitrary α value,

$$( \frac{α - 1}{α} ) N + 1 CBs$$

exist for a given port layouts,

$$N - \frac{N}{α} + 1 .$$

Another set (Set 2) of codebooks can be designed for any N/α consecutive ports, i.e., p_{δ}, p_{δ+1}, . . . , p_{δ+N/α-1}, where δ varies from 0 to

$$N ( 1 - \frac{1}{α} ) ,$$

which is [w′_{β+1} w′_{β+α+1} w′_{β+2α+1}, . . . , w′_{β+(N/α-1)α+1}], where β takes on value from 0 to α−1, i.e., a total of a possible codebooks for each of the

$$N ( 1 - \frac{1}{α} ) + 1$$

port selection combinations. This approach provides more flexibility in port selection at the expense of a limitation in codebook selection. For an arbitrary α value, α CBs exist for

$$( \frac{α - 1}{α} ) N + 1$$

port layouts and considering the aggregation of both Set 1 and Set 2 codebooks, the total number of possible codebooks is equal to 2(α−1)N+2α.

As described herein, the CSI reporting configuration 210 may indicate the sub-selection of antennas. In some embodiments, a number of port selections corresponding to selecting a subset of N/α consecutive ports over at least one dimension, e.g., i.e., p_{δ}, p_{δ+1}, and where a number of p_{δ+2}, . . . , p_{δ+Nα-1}, i.e., N/α ports, where

$$δ = 0 , 1 , … , N ( 1 - \frac{1}{α} ) ,$$

and where a number of possible port layouts is equal to

$$N ( 1 - \frac{1}{α} ) + 1 .$$

A corresponding number of DFT based codebooks is equal to α, corresponding to

$$\{ \begin{matrix}{w}_{β}^{′} & {w}_{β + α}^{′} & {w}_{β + 2 α}^{′} & … & {w}_{β + ( \frac{N}{α} - 1 ) α}^{′}\end{matrix} \} ,$$

where β is of any value from 0, . . . , α−1, e.g., a total of a possible DFT based codebooks, and w′ₖ is a vector of length N/α. Such an approach provides more flexibility in codebook selection given a limited port sub-selection.

For an arbitrary port selection, a DFT based codebooks exists, e.g., a total of N(α−1)+α DFT codebooks. In some cases, the selection of consecutive ports may be utilized when activating a subset of the antenna panel in large MIMO, while enabling the UE 104 to select a certain patch of antennas within the large MIMO array. Thus, it may be utilized for panel selection or in scenarios with spatial non-stationarity.

In an example implementation, the UE 104 is configured with receiving N ports and further configured with selecting a subset of the antennas that share the same characteristics. When the UE 104 realizes layout r is the best or is suitable, the UE 104 reports it to the NE 102, as (layout index)+corresponding CQI. The UE 104 may report the full PMI or the PMI for layout r+new CQI value. The UE 104 may then select the layout.

In some embodiments, a number of port selections corresponding to selecting a subset of ports of a spacing α, e.g., a number of ports in between any two selected ports is α−1 over at least one dimension, e.g., p_{δ}, p_{δ+α}, p_{δ+2α}, . . . , p_{δ+(N/α-1)α}, e.g., N/α ports, where δ=0,1, . . . , α−1, and where a number of possible port layouts is equal to α. A corresponding number of DFT based codebooks is equal to N, corresponding to

$$\{ \begin{matrix}{w}_{mod ( β , N )}^{′} & {w}_{mod ( β + 1 , N )}^{′} & … & {w}_{mod ( β + \frac{N}{α} - 1 , N )}\end{matrix} \} .$$

where β is of any value from 0, . . . , N−1, i.e., a total of N possible DFT based codebooks, and w′ₖ is a vector of length N/α. Such an approach provides more flexibility in codebook selection given limitation in port sub-selection. For an arbitrary port selection, N DFT based codebooks exists, e.g., a total of αN DFT codebooks. In some cases, the selection of spread out, or periodic, ports may be utilized to reduce the number of antennas, while allowing the UE 104 to toggle between different codebooks based on performance.

In an example implementation, the UE 104 is configured with receiving N ports and is further configured with reporting a smallest layout within δ CQI value of the full X ports. When the UE 104 realizes that layout r is the best or suitable, it reports it to the NE 102, as (layout index)+corresponding CQI. The UE 104 may then select the full PMI or the PMI for layout r+new CQI value.

In some embodiments, all port selection possibilities described herein may be combined. In some cases, a number of port selection possibilities for a given value of α is

$$N ( 1 - \frac{1}{α} ) + α + 1 .$$

In some cases, a number of DFT based codebooks for a given value of α is αN. In some cases, a number of port selection and DFT based codebook pairs for a given value of α is N(2α−1)+α.

In some embodiments, the UE 104 reports an indication of the selected subset of antennas in the CSI report (e.g., the CSI report 220). In some cases, the CSI report comprises an indication of a value of the parameter a, an event-based indication of whether a set of network-configured conditions that trigger a feedback of CSI corresponding to a selected subset of antennas has been met, and/or a value of the parameter a and the event-based indication are multiplexed to different codepoints of a same parameter. In some cases, a reporting of a second PMI, a second RI, and/or a second CQI, corresponding to a selected subset of ports, is conditioned on a reported value of the event-based indication.

In some embodiments, the UE 104 selects a same set of DFT column indices for the first PMI corresponding to the N ports and the second PMI corresponding to the selected subset of the N ports. For example, a second PMI for an N/2 antenna layout that corresponds to a selection of DFT basis columns of even IDs in the N-size DFT basis implies that the first PMI for an N antenna layout corresponds to a same selection of DFT basis columns, where the columns with even IDs are only considered.

In some embodiments, the UE 104 is configured with two power control offset values corresponding to the PDSCH Energy-Per-Resource Element (EPRE) to NZP CSI-RS EPRE, wherein a first power control offset value is associated with CSI corresponding to the set of CSI-RS ports, and a second power control offset value is associated with the subset of CSI-RS ports. In some cases, the UE 104 is configured with one power control offset value associated with the set of CSI-RS ports, and the UE 104 reports a second power control offset value associated with the subset of CSI-RS ports, where the second CQI value is based on the second power control offset value.

In some embodiments, the selection of a subset of ports may be based on a two-dimensional antenna array. A 2D antenna array includes N₁N₂ elements, where N₁ and N₂ denote horizontal and vertical array dimensions. The index of an element may be denoted by (n₁, n₂) where n₁∈{0, . . . , N₁−1} and n₂∈{0, . . . , N₂−1}. A spatial adaption pattern corresponds to a selection of antennas S₁×S₂ where S₁⊆{0, . . . , N₁−1} and S₂⊆{0, . . . , N₂−1}.

The CSI codebook corresponding to a 2D array includes beam vectors, each being the Kronecker product of two DFT vectors where one vector belongs to the set of N₁-dimensional DFT columns and the other belongs to the set of N₂-dimensional DFT columns. In other words the codebook consists of the columns of the matrix:

$$\tilde{F} = {F}_{{N}_{1}} ⊗ {F}_{{N}_{2}} , where$$

$${[ {F}_{{N}_{i}} ]}_{k , l} = \frac{1}{\sqrt{{N}_{i}}} exp ( j \frac{2 π kl}{{N}_{i}} ) , i = 1 , 2$$

A uniform selection of antennas may be a selection such that the following conditions below are satisfied:
mod_{N}_{₁}(|s₁−s₂|)=k d₁ for all s₁, s₂∈{0, . . . , N₁−1} for integers k and d₁, where d₁ is the spacing between consecutive selected indices in the horizontal direction and k can vary depending on the choice of s₁ and s₂; and
mod_{N}_{₂}(|s₁−s₂|)=k d₂ for all s₁, s₂∈{0, . . . , N₂−1} for integers k and d₂, where d₂ is the spacing between consecutive selected indices in the vertical direction and k can vary depending on the choice of s₁ and s₂ (e.g., in each of the horizontal and vertical directions, the antennas are selected uniformly).

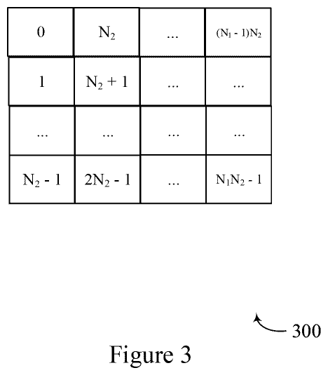

FIG. 3 illustrates an example diagram of an array of antennas 300 in accordance with aspects of the present disclosure. The array of antennas 300 is a 2D array of dimension (N₁, N₂). The 2D array has a horizontal dimension N₁ and vertical dimension N₂ and a corresponding indexing of antennas.

Given selection of a subset of antennas with index sets (S₁, S₂). This is equivalent to selecting the rows of \tilde{F} whose indices correspond to the elements selected elements. Also, binary selection vectors b₁ and b₂ can be defined where [b₁]ⱼ=1 if j∈S₁ and [b₁]ⱼ=0 if j∉S₁ and [b₂]ⱼ=1 if j∈S₂ and [b₂]ⱼ=0 if j∉S₂. In addition, \tilde{b}=b₁⊗b₂, where the support of \tilde{b} by the ordered set \tilde{S}={i₁<i₂< . . . <_{|S}_{₁}_{∥S}_{₂}_{|}}. Selection of the antennas may be equivalent to computing the product B\tilde{F} of dimension |\tilde{S}|×N₁N₂ where row [symbol] ₋₁=1 for i=1, . . . , |S₁∥S₂| and all other elements of B are equal to zero.

Let S₁ be the set of selected indices corresponding to a uniform selection of antennas in the horizontal direction with index spacing d₁ (mod_{N}_{₁}(|s₁−s₂|)=k d₁ for all s₁, s₂∈{0, . . . , N₁−1}) and S₂ be the set of selected indices corresponding to a uniform selection of antennas in the vertical direction with index spacing d₂ (mod_{N}_{₂}(|s₁−s₂|)=k d₂ for all s₁, s₂∈{0, . . . , N₁−1}). Similarly define

$${S}_{1}^{′} ∈ \{ 0 , 1 , … , {N}_{1} - 1 \} and {S}_{2}^{′} ∈ \{ 0 , 1 , … , {N}_{2} - 1 \}$$

as two index sets such that

$$\vert {S}_{1}^{′} \vert = \vert {S}_{1} \vert and \vert {S}_{2}^{′} \vert = \vert {S}_{2} \vert ,$$

corresponding to uniform selection of antennas with index spacings

$${d}_{1}^{′} and {d}_{2}^{′} .$$

If d₁=1, then select

$${S}_{1}^{′}$$

as any uniform selection of induces with a spacing

$${d}_{1}^{′} = {N}_{1} / \vert {S}_{1} \vert . If {d}_{1} > 1 , then select {S}_{1}^{′}$$

as any uniform selection indices with a spacing

$${d}_{1}^{′} = 1.$$

If d₂=1, then select

$${S}_{2}^{′}$$

as any uniform selection of indices with a spacing

$${d}_{2}^{′} = {N}_{2} / \vert {S}_{2} \vert . If {d}_{2} > 1 , then select {S}_{2}^{′}$$

as any uniform selection of indices with a spacing

$${d}_{2}^{′} = 1 .$$

With this selection, define the binary vectors

$${b}_{1}^{′} and {b}_{2}^{′} such {that [ {b}_{1}^{′} ]}_{j} = 1 if j ∈ {S}_{1}^{′} {and [ {b}_{1}^{′} ]}_{j} = 0 if j ∉ {S}_{1}^{′} {and [ {b}_{2}^{′} ]}_{j} = 1 if j ∈ {S}_{2}^{′} {and [ {b}_{2}^{′} ]}_{j} = 0 if j ∉ {S}_{2}^{′} .$$

Then, the set of columns of B\tilde{F} whose indices are given by the support of the vector

$${b}_{1}^{′} ⊗ {b}_{2}^{′}$$

forms a set of mutually orthogonal vectors.

The inner product of two columns in the matrix sub-sampled in rows via the selection of indices S₁ and S₂ is given as follows. Since the set of columns as selected above is represented by the support of \tilde{b}, every column in the set is associated with an index ( [symbol] ₁, [symbol] ₂) where

$${ℓ}_{1} ∈ {S}_{1}^{′} and {ℓ}_{2} ∈ {S}_{2}^{′} where {S}_{1}^{′} and {S}_{2}^{′}$$

are selected as described above. Selecting two columns (vectors) in the set corresponding to indices

$$( {ℓ}_{1} , {ℓ}_{2} ) and ( {ℓ}_{1}^{′} , {ℓ}_{2}^{′} ) .$$

The inner product of these two columns is given by:

$${g}_{( {ℓ}_{1} , {ℓ}_{2} )}^{H} {g}_{( {ℓ}_{1}^{′} , {ℓ}_{2}^{′} )} = \frac{1}{\sqrt{{N}_{1} {N}_{2}}} {\sum }_{{k}_{1} ∈ {S}_{1}} {\sum }_{{k}_{2} ∈ {S}_{2}} ( {e}^{- \frac{j 2 π {k}_{1} {ℓ}_{1}}{{N}_{1}}} {e}^{- \frac{j 2 π {k}_{2} {ℓ}_{2}}{{N}_{2}}} ) ( {e}^{- \frac{j 2 π {k}_{1}^{′} {ℓ}_{1}^{′}}{{N}_{1}}} {e}^{- \frac{j 2 π {k}_{2}^{′} {ℓ}_{2}^{′}}{{N}_{2}}} ) = \frac{1}{\sqrt{{N}_{1} {N}_{2}}} {\sum }_{{k}_{1} ∈ {S}_{1}} ( {e}^{- \frac{j 2 π {k}_{1} ( {ℓ}_{1} - {ℓ}_{1}^{′} )}{{N}_{1}}} ) {\sum }_{{k}_{2} ∈ {S}_{2}} ( {e}^{- \frac{j 2 π {k}_{2} ( {ℓ}_{2} - {ℓ}_{2}^{′} )}{{N}_{2}}} )$$

With the summation

$${sum}_{1} = {\sum }_{{k}_{1} ∈ {S}_{1}} ( {e}^{- \frac{j 2 π {k}_{1} ( {ℓ}_{1} - {ℓ}_{1}^{′} )}{{N}_{1}}} ) ,$$

if the spacing of selected antennas in the horizontal dimension is:

$${sum}_{1} = {e}^{j ϕ} {\sum }_{k = 0 , 1 , … , \vert {S}_{1} \vert - 1} ( {e}^{- \frac{j 2 π k ( {ℓ}_{1} - {ℓ}_{1}^{′} )}{{N}_{1}}} )$$

where φ is a phase value that does not depend on k. Now, if

$${S}_{1}^{′}$$

is selected according to the condition 1 above, then

$${ℓ}_{1} - {ℓ}_{1}^{′} = n \frac{{N}_{1}}{\vert {S}_{1}^{′} \vert} = n \frac{{N}_{1}}{\vert {S}_{1} \vert} for some n ∈ \{ - \vert {S}_{1} \vert - 1 , … , \vert {S}_{1} \vert - 1 \} , and$$

$${sum}_{1} = {e}^{j ϕ} {\sum }_{k = 0 , 1 , … , \vert {S}_{1} \vert - 1} ( {e}^{- \frac{j 2 π kn}{\vert {S}_{1} \vert}} ) .$$

If n≠0, then sum₁=0. The same conclusion holds for the case where d₁>1 (e.g., spacing of selected antennas in the horizontal direction larger than one) and

$${S}_{1}^{′}$$

is any uniform selection of induces with a spacing

$${d}_{1}^{′} = 1 ( condition 2 ) .$$

The same conclusion also holds for the second summation, where:

$${sum}_{2} = {\sum }_{{k}_{2} ∈ {S}_{2}} ( {e}^{- \frac{j 2 π {k}_{2} ( {ℓ}_{2} - {ℓ}_{2}^{′} )}{{N}_{2}}} ) .$$

Thus, with the selection of the set of columns as above (e.g., satisfying the four conditions), the inner product of any two distinct columns is zero, and there is a mutually orthogonal set of column vectors. Therefore, for any uniform selection of 2D antennas, there are multiple subsets of columns in the codebook of columns \tilde{F}=F_{N}_{₁}⊗F_{N}_{₂} whose sub-sampling, corresponding to the selection of antennas, results in a set of mutually orthogonal vectors.

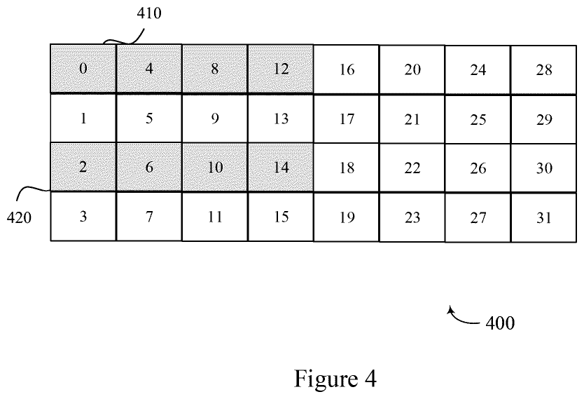

FIG. 4 illustrates an example diagram of a selection of antennas 400 in accordance with aspects of the present disclosure. For example, given an array of dimension (N₁, N₂)=(8,4), as depicted, a first set of antennas 410 and a second set of antennas 420 are selected.

Thus, if S₁={0,1,2,3} and S₂={0,2}, the sets

$${S}_{1}^{′} and {S}_{2}^{′}$$

can be selected as follows.

$${S}_{1}^{′} ⊆ \{ 0 , … , 7 \}$$

and is of dimension 4,

$${S}_{2}^{′} ⊆ \{ 0 , … , 3 \}$$

and of dimension 2. It follows that:

$${S}_{1}^{′}$$

can be chosen as the set {0,4,4,6} or any shift of this, e.g., {1,3,5,7};

$${S}_{2}^{′}$$

can be chosen as the set {0,1} or ally cyclic shift of this, e.g., {1,2}, {2,3}, {3,0}; and
a set of valid column indices of DFT-based matrix F may be:

$${{⋃}_{{i}_{1} = 0 , {i}_{2} = 0}}^{{i}_{1} = \vert {S}_{1} \vert - 1 , {i}_{2} = \vert {S}_{2} \vert - 1} {S}_{2}^{′} ( {i}_{2} ) + {N}_{2} {S}_{1}^{′} ( {i}_{1} )$$

For example, the following column indices {0,1,8,9,16,17,24,25} of \tilde{F} are a result of selecting

$${S}_{1}^{′} = \{ 0 , 2 , 4 , 6 \} and {S}_{2}^{′} = \{ 0 , 1 \} .$$

$$When {S}_{1}^{′} = \{ 1 , 2 \} and {S}_{2}^{′} = \{ 1 , 3 , 5 , 7 \} ,$$

the column indices {5,6,13, 14,21,22,29,30} are selected, and when

$${S}_{1}^{′} = \{ 3 , 0 \} and {S}_{2}^{′} = \{ 1 , 3 , 5 , 7 \} ,$$

the column indices {4,7,12,15,20,23,28,31} are selected. In some cases, any combination of these valid selections of S₁ and S₂ may result in the selection of a set of orthogonal column vectors from \tilde{F}.

In some embodiments, the UE 104 reports indices of selected antennas over each of the N₁ dimension and the N₂ dimension independently, e.g., S₁ and S₂ are reported separately. For example, a selection of antenna ports {0,2,4,6,8, 10,12,14} for an antenna layout wherein {N₁,N₂}={8,4} is reported or indicated separately via indicators S₁={0,1,2,3} and S₂={0,2} over the N₁ dimension and N₂ dimension, respectively.

In some embodiments, the UE 104 reports indices of selected antennas over each of the N₁ dimension and the N₂ dimension jointly, i.e., S₁ and S₂ are reported jointly. For example, a selection of antenna ports over S₁={0,1,2,3} and S₂={0,2} is represented via a union of all values of S₂(n₂)+N₂S₁(n₁) for all n₁, n₂ selected indices, e.g., with the set {0,2,4,6,8,10,12,14} of antenna elements over the N₁ and N₂ antenna dimensions.

In some embodiments, the UE 104 reports indices of selected columns of DFT-based matrix \tilde{F} over the N₁ dimension and the N₂ dimension independently, i.e.,

$${S}_{1}^{′} and {S}_{2}^{′}$$

are reported separately. For example,

$${S}_{1}^{′}$$

can be chosen as the set {0,2,4,6} or {1,3,5,7}, and/or

$${S}_{2}^{′}$$

can be chosen as the set {0,1} or any cyclic shift of this, e.g., {1,2}, {2,3}, {3,0}.

In some embodiments, the UE 104 reports indices of selected columns of DFT-based matrix \tilde{F} over the N₁ dimension and the N₂ dimension jointly, i.e.,

$${S}_{1}^{′} and {S}_{2}^{′}$$

are reported jointly. For example, a selection of antenna ports {0,2,4,6,8,10,12,14} for an antenna layout wherein {N₁,N₂}={8,4} along with

$${S}_{1}^{′} = \{ 0 , 2 , 4 , 6 \} and {S}_{2}^{′} = \{ 0 , 1 \}$$

corresponds to matrix \tilde{F} column indices {0,1,8,9,16,17,24,25}. When,

$${S}_{1}^{′} = \{ 1 , 2 \} and {S}_{2}^{′} = \{ 1 , 3 , 5 , 7 \}$$

the column indices {5,6,13,14,21,22,29,30} are selected. When

$${S}_{1}^{′} = \{ 3 , 0 \} and {S}_{2}^{′} = \{ 1 , 3 , 5 , 7 \} ,$$

the column indices {4,7,12,15,20,23,28,31} are selected.

### CSI Acquisition and Reporting

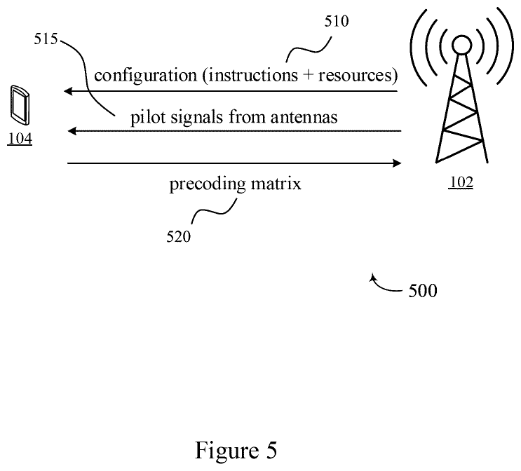

FIG. 5 illustrates an example signaling between the UE 104 and the NE 102 in accordance with aspects of the present disclosure. As described herein, the NE 102 transmits a configuration message 510 to the UE 104. The configuration message 510 may include instructions (e.g., steps to be performed by the UE 104 during CSI acquisition/measurement/reporting) and identifies resources to be utilized by the UE 104. In some cases, the configuration message 510 is or incudes the CSI reporting configuration 210. The NE 102 also transmits pilot signals 515 (e.g., CSI-RS) from various antennas of the NE 102 (e.g., antennas of a BS).

The UE 104 estimates the channel based on the received pilot signals 515 and computes or otherwise determines a precoding matrix that matches the estimated channel (e.g., which enables the NE 102 to beamform to the UE 104). The UE 104 transmits the precoding matrix via a CSI report (e.g., the CSI report 220) or other configured CSI feedback.

In some embodiments, a codebook may be designed to facilitate the sub-selection. For example, the NE 102 configures the UE 104 with receiving a set of N CSI-RS ports, and further configures the UE 104 with a value a corresponding to a scaling down of the selected ports to a value of N/α, where the UE 104 is configured to (optionally) select N/α ports of the N ports based on conditions of the layout of the selected N/α ports over at least one dimension, and a set of performance constraints corresponding to the selected N/α ports compared with the N ports.

The UE 104 estimates the WB channel over the N ports and measures the received energy over the N DFT-based column vectors (e.g., N values corresponding to the energy over H·F_{N}, e.g., each of the columns of H·F_{N}).

For a given value of α, the UE 104 orders the column indices of F_{N} in descending order with respect to received energy. As described herein, for a sub-selection of N/α antenna ports, α+N different sets of DFT column vector indices of F_{N} maintain orthogonality based on the first and the second sets of codebook design. The UE 104 identifies whether any of the α+N different sets of DFT column vector indices (based on first and second set of codebook designs) comprise the strongest

$$⌈ \frac{{v}_{max}}{2} ⌉$$

DFT column vectors (assuming Type-I CB) or L DFT column vectors (assuming Type-II CB), or at least whether

$$⌈ \frac{{v}_{max}}{2} ⌉$$

or L DFT column vectors in any of the α+N different sets captures at least ψ% of the total energy of the best

$$⌈ \frac{{v}_{max}}{2} ⌉$$

or L DFT column vectors, where the value of ψ is either fixed, network configured or based on UE implementation, e.g., ψ=90. This may correspond to selecting a DFT vector sub-selection matrix S, similar to that in equation \tilde{B}=P·B·S^{T}.

When the energy condition is met (e.g., otherwise end the procedure), the UE 104 selects a best port layout corresponding to a port selection matrix P from either the

$$N ( 1 - \frac{1}{α} ) + 1$$

or α port layouts, based on the received energy of these ports and based on the selected codebook subsampling matrix S, similar to that in equation \tilde{B}=P·B·S^{T}. The UE 104 reports an index of the selected port layout, as well as a corresponding selected codebook, and reports a second CQI to the network corresponding to the N/α selected port layout.

The NE 102 infers the precoding matrix V′ for the N/α selected port layout for the RI layers from the reported PMI for the N port layout, via applying V′=P·V. In some cases, the selected N/α port layout is not reported, and instead the second CQI corresponds to a smallest CQI value for either the

$$N ( 1 - \frac{1}{α} ) + 1$$

or α pull layouts based on a selected codebook from one of the α or N possible DFT codebooks, where an identifier of the selected DFT codebook index for the N/α ports is also reported.

Thus, in various embodiments, the technology described herein may identify antenna port selection conditions under which an orthogonality of the DFT-based PMI vectors is not violated, enable reusing a PMI value associated with a full set of antenna ports to compute a second PMI value corresponding to a selected subset of antenna ports, based on a set of conditions associated with a set of beams selected from a set of columns of a DFT matrix, and identify signaling corresponding to selection of the subset of ports as well as CSI feedback associated with the antenna subset selection, where the CSI corresponding to the selected antenna subset is inferred from the CSI corresponding to the full PMI.

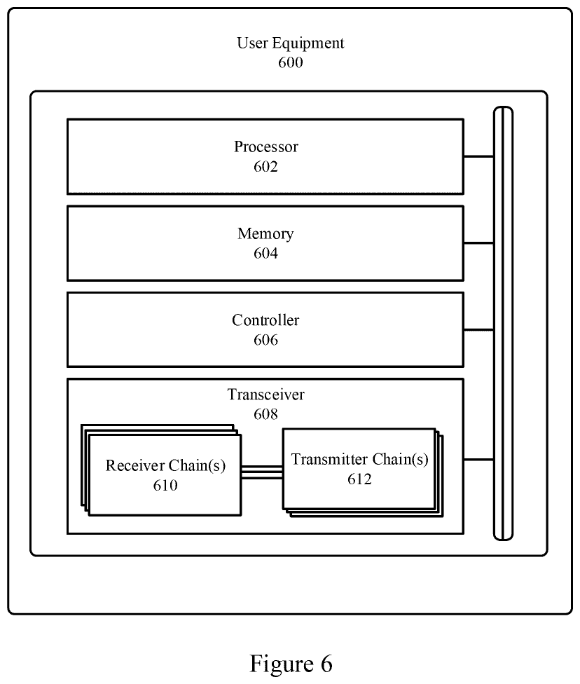

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving a configuration for CSI reporting, wherein the configuration includes a set of metrics, receiving a CSI-RS associated with-a set of CSI-RS ports, identifying a subset of CSI-RS ports from the set of CSI-RS ports based on the configuration, generating a set of CSI parameters comprising a first group of CSI parameter values associated with the set of CSI-RS ports and a second group of CSI parameter values associated with the subset of CSI-RS ports, wherein a subset of the second group of CSI parameter values is based at least in part on the first group of CSI parameter values, and transmitting a CSI report comprising a subset of the set of CSI parameters based on the set of metrics.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

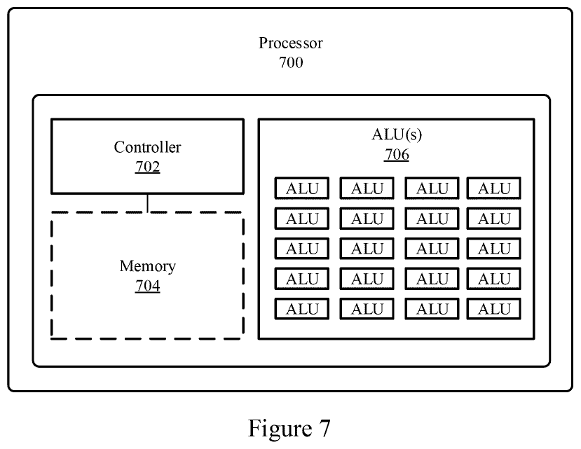

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. For example, the processor 700 may be configured to support a means for transmitting, to a UE, a configuration for CSI reporting that includes a set of metrics, transmitting, to the UE, a CSI-RS identifying a set of CSI-RS ports, and receiving, from the UE, a CSI report that comprises values associated with the set of CSI-RS ports and values associated with a subset of CSI-RS ports.

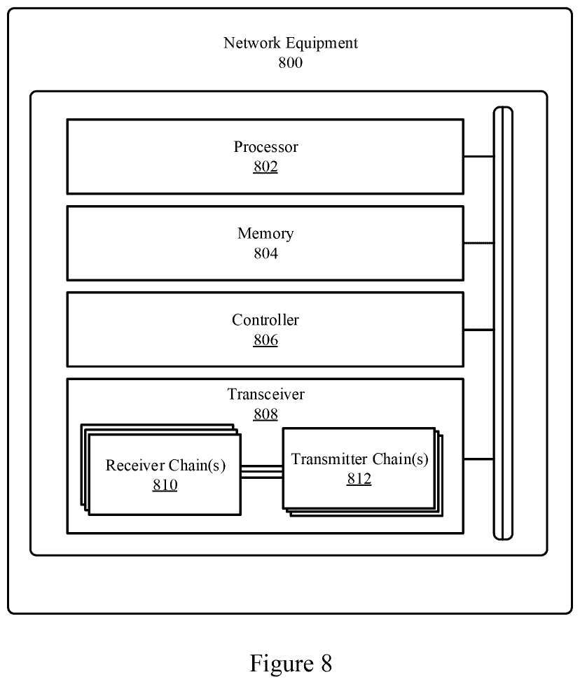

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804).

For example, the processor 802 may support wireless communication at the NE 800 in accordance with examples as disclosed herein. The NE 800 may be configured to support a means for transmitting to a UE a configuration that identifies an LCP procedure to apply to multiple logical channels associated with data units within a buffer of the UE, wherein the LCP procedure prioritizes delay-critical PDUs or delay-critical SDUs during LCP, and receiving, from the UE, a PUSCH transmission from the UE based on the identified LCP procedure.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

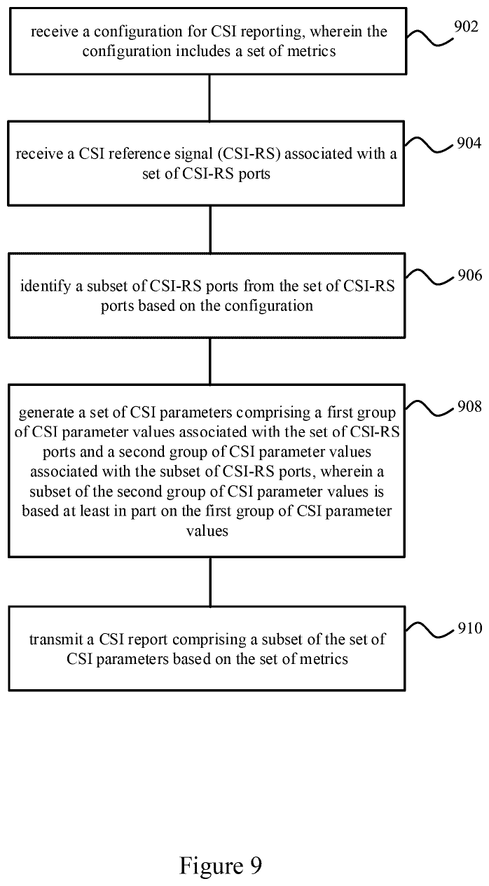

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving a configuration for CSI reporting, wherein the configuration includes a set of metrics. The operations of 902 may be performed in accordance with examples as described herein. In some implementations, aspects of the operations of 902 may be performed by a UE as described with reference to FIG. 6.

At 904, the method may include receiving a CSI-RS associated with-a set of CSI-RS ports. The operations of 904 may be performed in accordance with examples as described herein. In some implementations, aspects of the operations of 904 may be performed by a UE as described with reference to FIG. 6.

At 906, the method may include identifying a subset of CSI-RS ports from the set of CSI-RS ports based on the configuration. The operations of 906 may be performed in accordance with examples as described herein. In some implementations, aspects of the operations of 906 may be performed by a UE as described with reference to FIG. 6.

At 908, the method may include generating a set of CSI parameters comprising a first group of CSI parameter values associated with the set of CSI-RS ports and a second group of CSI parameter values associated with the subset of CSI-RS ports, wherein a subset of the second group of CSI parameter values is based at least in part on the first group of CSI parameter values. The operations of 908 may be performed in accordance with examples as described herein. In some implementations, aspects of the operations of 908 may be performed by a UE as described with reference to FIG. 6.

At 910, the method may include transmitting a CSI report comprising a subset of the set of CSI parameters based on the set of metrics. The operations of 910 may be performed in accordance with examples as described herein. In some implementations, aspects of the operations of 910 may be performed by a UE as described with reference to FIG. 6.

It should be noted that the method described herein describes a possible implementation, and that the operations and the steps may be rearranged or otherwise modified and that other implementations are possible.

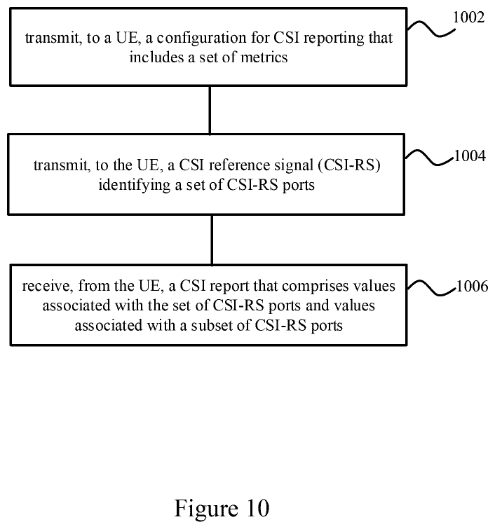

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may include transmitting, to a UE, a configuration for CSI reporting that includes a set of metrics. The operations of 1002 may be performed in accordance with examples as described herein. In some implementations, aspects of the operations of 1002 may be performed by an NE as described with reference to FIG. 8.

At 1004, the method may include transmitting, to the UE, a CSI-RS identifying a set of CSI-RS ports. The operations of 1004 may be performed in accordance with examples as described herein. In some implementations, aspects of the operations of 1004 may be performed by an NE as described with reference to FIG. 8.

At 1006, the method may include and receiving, from the UE, a CSI report that comprises values associated with the set of CSI-RS ports and values associated with a subset of CSI-RS ports. The operations of 1006 may be performed in accordance with examples as described herein. In some implementations, aspects of the operations of 1006 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a configuration for channel state information (CSI) reporting, wherein the configuration includes a set of metrics;
receive a CSI reference signal (CSI-RS) associated with a set of CSI-RS ports;
identify a subset of CSI-RS ports from the set of CSI-RS ports based on the configuration;
generate a set of CSI parameters comprising a first group of CSI parameter values associated with the set of CSI-RS ports and a second group of CSI parameter values associated with the subset of CSI-RS ports, wherein a subset of the second group of CSI parameter values is based at least in part on the first group of CSI parameter values; and
transmit a CSI report comprising a subset of the set of CSI parameters based on the set of metrics.

2. The UE of claim 1, wherein the CSI report comprises:
one or more precoder matrix indicator (PMI) values comprising coefficients associated with the set of CSI-RS ports;
one or more rank indicator (RI) values associated with the set of CSI-RS ports;
a first channel quality indicator (CQI) value associated with the set of CSI-RS ports; and
a second CQI value associated with the subset of CSI-RS ports.

3. The UE of claim 2, wherein the first group of CSI parameters values comprises a PMI value of the one or more PMI values, an RI value of the one or more RI values, and the first CQI value, and wherein the second group of CSI parameter values comprises the second CQI value.

4. The UE of claim 3, wherein at least one of:
a precoding matrix associated with the subset of CSI-RS ports is inferred from the PMI value; and
a rank value associated with the subset of CSI-RS ports is inferred from the RI value.

5. The UE of claim 1, wherein the at least one processor is configured to cause the UE to receive the CSI-RS over one or more non-zero power (NZP) CSI-RS resources, and wherein the one or more NZP CSI-RS resources comprise one or more groups of CSI-RS ports that correspond to the set of CSI-RS ports.

6. The UE of claim 4, wherein the set of CSI-RS ports are distributed over two dimensions, and wherein the at least one processor is further configured to cause the UE to select the subset of CSI-RS ports independently over each dimension of the two dimensions.

7. The UE of claim 1, wherein the set of metrics comprises:
a difference between a first channel quality indicator (CQI) value and a second CQI value being less than or equal to a first threshold value;
a difference between a first rank indicator (RI) value associated with the set of CSI-RS ports and a second RI value associated with the subset of CSI-RS ports being less than or equal to a second threshold value;
a range of values for a quantity of CSI-RS ports of the set of CSI-RS ports that satisfies a set of conditions associated with a layout of the CSI-RS ports; or
a combination thereof.

8. The UE of claim 7, wherein:
the subset of the set of CSI parameters comprises the first group of values and the second group of values based at least in part on the set of metrics being satisfied, or
the subset of the set of CSI parameters comprises the first group of values based at least in part on the set of metrics not being satisfied.

9. The UE of claim 1, wherein:
a number of CSI-RS ports of the subset of CSI-RS ports are consecutive over at least one dimension; or
the number of CSI-RS ports of the subset of CSI-RS ports are non-consecutive over the at least one dimension and with uniform gaps between each CSI-RS port and subsequent CSI-RS port of the number of CSI-RS ports.

10. The UE of claim 9, wherein coefficients of one or more precoder matrix indicator (PMI) values are based on a codebook comprising a set of columns of a discrete Fourier transform (DFT)-based matrix.

11. The UE of claim 10, wherein an indexing of columns of the DFT-based matrix is circular, wherein a last column of the DFT-based matrix and a first column of the DFT-based matrix are consecutive columns.

12. The UE of claim 10, wherein the subset of CSI-RS ports corresponds to the number of CSI-RS ports that are consecutive, and wherein the codebook is based on a subset of non-consecutive columns of the DFT-based matrix with a uniform gap between identifiers of each column and subsequent column of the non-consecutive columns.

13. The UE of claim 10, wherein the subset of CSI-RS ports corresponds to the number of CSI-RS ports that are non-consecutive, and wherein the codebook is based on a subset of consecutive columns of the DFT-based matrix.

14. The UE of claim 10, wherein the second group of CSI parameter values further comprises:
an indication of a subset of columns of the DFT-based matrix based on the subset of CSI-RS ports;
an indication of the subset of CSI-RS ports; or
a combination thereof.

15. A network node for wireless communication, comprising:
at least one memory; and
at least one processor coupled with the at least one memory and configured to cause the network node to:
transmit, to a user equipment (UE), a configuration for channel state information (CSI) reporting that includes a set of metrics;
transmit, to the UE, a CSI reference signal (CSI-RS) identifying a set of CSI-RS ports; and
receive, from the UE, a CSI report that comprises values associated with the set of CSI-RS ports and values associated with a subset of CSI-RS ports.

16. The network node of claim 15, wherein the configuration includes information identifying a spatial adaption pattern or antenna array at the network node that is associated with the subset of CSI-RS antenna ports.

17. The network node of claim 15, wherein the configuration includes information an indication of a quantity of CS-RS ports of the subset of CSI-RS antenna ports.

18. A processor for wireless communication, comprising:
at least one controller coupled with at least one memory and configured to cause the processor to:
receive a configuration for channel state information (CSI) reporting, wherein the configuration includes a set of metrics;
receive a CSI reference signal (CSI-RS) associated with-a set of CSI-RS ports;
identify a subset of CSI-RS ports from the set of CSI-RS ports based on the configuration;
generate a set of CSI parameters comprising a first group of CSI parameter values associated with the set of CSI-RS ports and a second group of CSI parameter values associated with the subset of CSI-RS ports, wherein a subset of the second group of CSI parameter values is based at least in part on the first group of CSI parameter values; and
transmit a CSI report comprising a subset of the set of CSI parameters based on the set of metrics.

19. The processor of claim 18, wherein the CSI report comprises:
one or more precoder matrix indicator (PMI) values comprising coefficients associated with the set of CSI-RS ports;
one or more rank indicator (RI) values associated with the set of CSI-RS ports;
a first channel quality indicator (CQI) value associated with the set of CSI-RS ports; and
a second CQI value associated with the subset of CSI-RS ports.

20. A method performed by a user equipment (UE), the method comprising:
receiving a configuration for channel state information (CSI) reporting, wherein the configuration includes a set of metrics;
receiving a CSI reference signal (CSI-RS) associated with-a set of CSI-RS ports;
identifying a subset of CSI-RS ports from the set of CSI-RS ports based on the configuration;
generating a set of CSI parameters comprising a first group of CSI parameter values associated with the set of CSI-RS ports and a second group of CSI parameter values associated with the subset of CSI-RS ports, wherein a subset of the second group of CSI parameter values is based at least in part on the first group of CSI parameter values; and
transmitting a CSI report comprising a subset of the set of CSI parameters based on the set of metrics.
